(19) United States
(12) Patent Application Publication
(10) Pub. No.: US 2016/0231716 A1
(43) Pub. Date: Aug. 11, 2016

(54) SYSTEM OF SYSTEMS OPTIMIZING CONTROL FOR ACHIEVING PERFORMANCE AND RISK OUTCOMES IN PHYSICAL AND BUSINESS OPERATIONS OF CONNECTED AND INTERRELATED INDUSTRIAL SYSTEMS

(71) Applicant: General Electric Company, Schenectady, NY (US)

(72) Inventors: Christopher Donald Johnson, Niskayuna, NY (US); Rajesh Tyagi, Niskayuna, NY (US); Radhakrishnan Poomari, Bangalore (IN); Ilkin Onur Dulgeroglu, Niskayuna, NY (US)

(21) Appl. No.: 15/019,649

(22) Filed: Feb. 9, 2016

Related U.S. Application Data
(60) Provisional application No. 62/114,498, filed on Feb. 10, 2015.

(51) Int. Cl. G05B 13/04

(52) U.S. Cl. CPC G05B 13/041

(57) ABSTRACT

Aspects of the present disclosure relate to a system comprising a computer-readable storage medium storing at least one program and a method for optimizing and controlling the physical and business aspects of an industrial system. In example embodiments, the method may include assessing criteria to be applied to an industrial system, and generating simulation scenarios based on the criteria. The method may further include simulating each of the simulation scenarios over a period of time to generate simulated physical aspects and simulated business aspects of the industrial system for each of the plurality of simulation scenarios. The method may further include identifying at least one of the simulation scenarios for use with the industrial system based on a comparison of the simulated physical aspects and the simulated business aspects corresponding to each simulation scenario.

### CLAIM OF PRIORITY

This application claims the benefit of priority under 35 U.S.C. §119(e) to U.S. Provisional Patent Application Ser. No. 62/114,498, filed on Feb. 10, 2015, the benefit of priority of which is claimed hereby, and which is incorporated by reference herein in its entirety.

### TECHNICAL FIELD

This application relates generally to the field of data processing and, in an example embodiment, to the optimization of industrial systems based on technical and business objectives and constraints.

### BACKGROUND

A large, complex industrial system, such as, for example, a power plant, may be viewed as both a physical system and a business system, as the purpose of such a system is typically to create an economic return for the owner and/or operator of the system while also providing some physical benefit, such as power generation capability. Oftentimes, balancing these interests involves adjusting various aspects of the industrial system, such as, for example, the cost and technical capabilities of the components of the system, the configuration of those components, the specific operations of the system, the maintenance applied to the system, and myriad other factors. In addition, other factors that are not within the direct control of the system owner or operator, such as the weather, the cost of fuel consumed by the system, the market price of the commodity generated by the system, and so on, may also effect the overall operations, reliability, produced physical benefit, and resulting profitability of the system.

Given the potential number of factors and the overall complexity normally associated with such a system, determining the components, configuration, operation, maintenance, and other parameters of the system that result in an enhanced return in value for the owner or operator while delivering the expected or desired physical benefit is typically ad hoc in nature as well as time-consuming.

### BRIEF DESCRIPTION OF DRAWINGS

The present disclosure is illustrated by way of example and not limitation in the figures of the accompanying drawings, in which like references indicate similar elements and in which:

FIG. 1 is a graph illustrating a relationship between example choices and example operational paths associated with an example industrial system;

FIG. 2 is a block diagram of an example simulator/optimizer configured to optimize various aspects of an example industrial system;

FIG. 3 is block diagram of an example criteria module employed in the example simulator/optimizer of FIG. 2;

FIG. 4 is flow diagram of an example method of physical and business optimization of an industrial system;

FIG, 5 is a graph illustrating the possible economic or operational results associated with each of a number of scenarios;

FIG. 6 is a graphical representation of an example decision support interface;

FIG. 7 is a graph illustrating the performance of an industrial system relative to system owner preferences with respect to the ratio of financial or operational risk and return relationships;

FIG. 8 is a graphical representation of an example user interface of the industrial system;

FIG. 9 is a flow diagram of an example data flow of the industrial system;

FIG. 10 is a time-based diagram of an example simulation of a complex industrial system;

FIG. 11 is a graphical representation of an example discrete event simulation of a business-physical system run over time and across randomness; and

FIG. 12 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that exemplify illustrative embodiments. In the following description, for purposes of explanation, numerous specific details are set forth to provide an understanding of various embodiments of the subject matter. It will be evident, however, to those skilled in the art that embodiments of the subject matter may be practiced without these specific details. In general, well-known instruction instances, protocols, structures, and techniques have not been shown in detail.

Example embodiments involve a system that financially values and co-optimizes the design and operating policy choices of a complex industrial system (e.g., a power plant) thereby achieving multiple objectives beyond financial value creation and/or risk reduction. In actual practice, complex engineered systems used in industrial processes have a business context such as contractual service agreements, capital financing terms and covenants, interconnect policy, regulatory policy, and competitive substitutes in their served markets. Conventional techniques for industrial ecosystem optimization may consider aspects and silos of economic value for subsets of complex engineered industrial systems, but do not allow the discovery of system constraints, the co-optimization of multiple objectives with design and/or operational decision support over an economic or operational interval. However, optimizing an industrial ecosystem without consideration of the multitude of objectives and constraints or considering the ecosystem's many existing constraints for the purposes of asset design and operating policy may trap economic or other aspects of value.

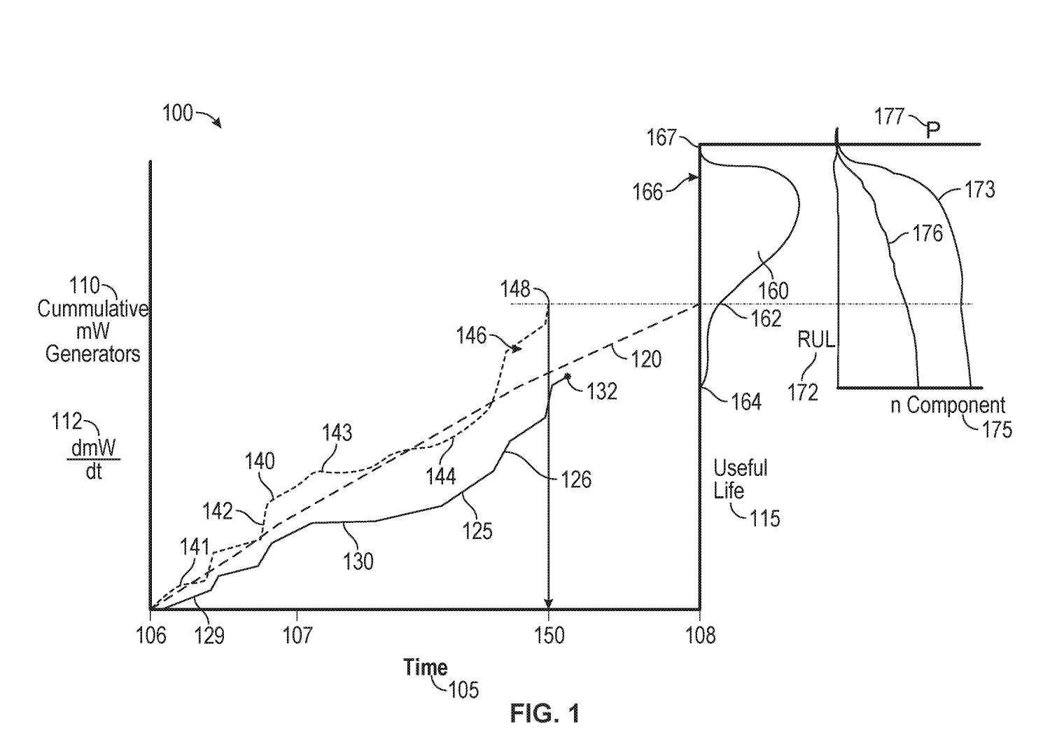

FIG. 1 is a graph 100 illustrating example operational paths associated with an example industrial system. In particular, the graph 100 depicts a first operational path 120 and a second operational path 125 (e.g., as actual operations or a simulated scenario or replication) over time 105 for operating an industrial system such as a gas turbine power plant. In addition, a useful life consumption path 140 arising from the use of the second operational path 125 is also shown in FIG.1.

Generally, component parts and subsystems of the example industrial system operate over time such that the useful life of those components is consumed during that time. Accordingly, the industrial system needs maintenance from time to time to replace or rebuild the component parts or the entirety of the industrial system. How the industrial system is operated with respect to the temperatures, pressures, and stresses resulting from the chosen operations and/or control settings will impact the remaining useful life 115 at a given probability and/or reliability 140.

More specifically with respect to FIG. 1, the first operational path 120 depicted therein represents a steady-state operation of the plant for a design or assigned load at a constant power generation rate 112 (e.g., in megawatts per unit time, or dMW/dt). In some embodiments the operational path 120 may also be a base case plan to which other plans of operating the industrial system may be compared to. Consequently, the plant and/or its subsystems 175 will reach a particular reliability level 162 with a corresponding outage point and associated maintenance time 108 at a specified reliability probability 160 (e.g., probability of remaining useful life) for the specified subsystems 175 that are employed for system operation.

Relative to the first operational path 120, the second operational path 125 results in a variable power generation rate 112 over time 105, with periods of operation matching a load point whose power generation rate 112 is the plan or design operating point for the physical system, a steady-state rate segment 129 during which the system consumes differentially less useful life 115, a rate segment 126 which consumes differentially more useful life 115, and a shut off rate 130 during which the system differentially under-consumes useful life 115 of the overall plant or for a targeted subsystem 175, such as a life-limiting apparatus or component of the plant.

The useful life consumption path 140 represents the life consumption for the entire system resulting from the second operational path 125. In some examples, subsystems 175 of the system or plant may be tracked as well on that the useful life 115 of each subsystem 175 may be managed by identifying upgrades, performing plant configurations (e.g., “lineups”), and scheduling and scoping maintenance.

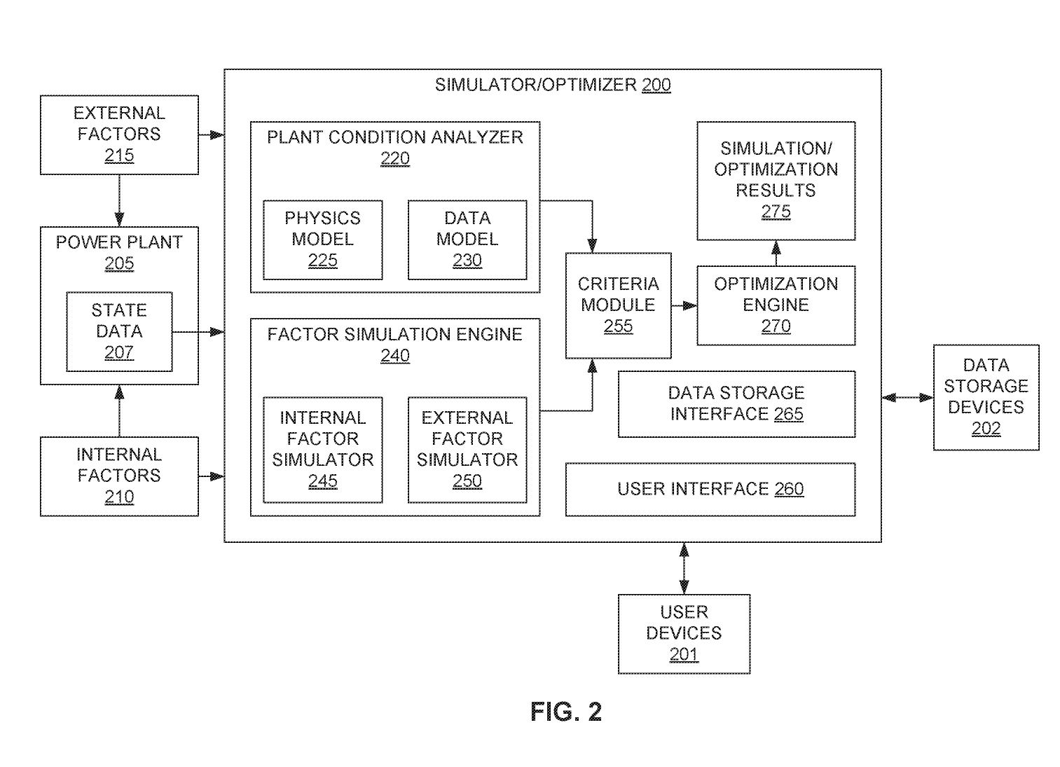

Life consumption of an industrial system is typically nonlinear outside of a “normal” or design operations point or range. At the system level, some compensation for physical stress avoidance can be made, such as by setting a control configuration that preserves life of the plant but sacrifices efficiency, such as during useful life segment 146. Such configurations, as well as other operations, control, maintenance work scope, and other physical and business aspects of the plant, may help manage economic aspects or other aspects of value related to the plant. For example, managing operations, control, and maintenance work scope so that the useful life segment 146 is at a desired reliability probability 160 at a certain time 105 may be accomplished. In at least some embodiments, these and other aspects of the plant may be managed concurrently, such as commercial operations, lineups, maintenance, service work scopes, upgrades, and control points. An example system, described in greater detail below in conjunction with FIG. 2, may determine such managed aspects to enhance the economic value of the plant.

FIG. 1, as mentioned above, graphically depicts the relationship between the plant or system generation rate 110, time 105, and useful life 115 consumption for the second operational path 125 and its associated useful life consumption path 140 beginning at time 106 for either a new unit or a repaired unit whose state is known, or any subsystem 175 being tracked. A steady-state rate segment at the rated load results in linear life consumption segment. Thereafter, at a given future time 108 the system is stressed when another operation segment 146 exceeds full load (e.g., at the end of a typical operations range) and differentially consumes useful life 115 at a relatively high rate during life operation segment 146. During an operational segment (shut off rate 130) at which partial or no load is imposed on the system, the rate of life consumption at corresponding life consumption segment 143 is reduced, or near zero. At a future operational segment 126, the corresponding useful life segment 146 may be extremely high, but may be reduced by a control setting which may lower system efficiency in exchange for a reduced life consumption rate. The “system-of-systems” simulation and optimizer, to be described later with respect to FIG. 2, utilizes a cumulative life consumption, as depicted in FIG. 1, based upon the current cumulative state of the plant, maintenance timing and scope to adjust service duty, control settings, maintenance, lineups, and commercial operations, to compare various scenarios.

The operational segment 126 described above serves as an example of how interaction between operations, maintenance, design, and various business considerations may be employed to describe an example of a plant design change that enables the corresponding operation segment 146 to be lower than it otherwise would have been under more typical circumstances. In the industrial system or plant being simulated, a scenario may be investigated that beneficially takes advantage of, for example, a peak demand pricing opportunity and specifies the commercial market offer to bid for the associated extra load. The simulator may then dispatch the simulated plant at a probability at which the offer was accepted, may simulate the plant as differentially consuming life according to the load, may set the remaining useful life point as a function of reliability and/or repair work scope to the subsystems of the plant, and may trade off the costs and scope of a changed outage and fuel purchase. The plant simulator may also execute a different set of scenario runs using, for example, a catalog of available design modifications, updates, and operational decision policy changes. Consequently, the scenarios which install a certain control system upgrade which allowed the useful life segment 146 to be reduced, even though subsequently causing more fuel to be consumed, may provide a higher return on investment over the simulated economic lifecycle than other alternatives. Thus, the simulation/optimization system described herein may identify a design modification to the industrial system that would achieve optimum or at least enhanced economic risk and/or return preferences and/or other metrics of value.

In some embodiments, similar to the identification of a valuable upgrade to a subsystem of the industrial system, as provided above, the simulation/optimization system may also adjust repair work scope and/or its timing with operations alternatives. A possible base-case scenario is that the plant employs the first operational path 120 to arrive at a specified maintenance event scheduled for time 108 with remaining useful life (RUL) 172, which represents a chosen reliability probability (e.g., reliability probability 160 of remaining useful life). The simulator/optimizer may track the subsystems 175 to develop or determine the overall useful life 115 and reliability of the plant. The simulator/optimizer may then determine that moving the outage point from time 108 to time 150 by consuming the life of the plant using the second operational path 125 is more beneficial from the perspective of economic value (or some other metric of value) compared to the base-case scenario of the first operational path 120.

Alternatively, presuming the maintenance timing is fixed at time 108, as is the RUL 172, for a specified reliability probability 160 for the set of subsystems 175, the simulator/optimizer may assess possible operations and/or control of the plant for superior risk/return or other metrics of value. Accordingly, plant operation segments (indicated by reference numbers 129, 130, 125, 126, and 132) along second operational path 125 may be bid, dispatched, and/or controlled so that the plant may arrive at time 108 at a specified reliability probability 160 (e.g. the probability of a physical impairment or failure of the plant or subsystem) while providing an optimized return on investment. Further, if it is infeasible to meet operation segment 125, an outage at time 150, and/or repair or uprate work scope that impacts useful life on a subsystem 175, at a reliability probability 160, that also results in a set of cash flows or other metrics of value as defined by a stakeholder of the industrial system, that is acceptable, then the available choices (operations, timing, repair scope, reliability, efficiency, design, lineups) are sequentially relaxed parametrically and/or concurrently in order to calculate the opportunity cost of that choice element, which is treated as a system constraint(s) which the decision maker may decide to relax or the financial optimizer may choose to relax.

Generally, as described above, the simulator/optimizer may alter the operating risk (e.g., particular reliability level 162) using the first operational path 120 as a function of the economics or other aspects of value when more aggressive bid, dispatch, and operations, despite the added risk of arriving at outage schedule at a higher risk point 166, are differentially compensated for over the economic time interval being simulated and optimized.

In example embodiments, the simulator/optimizer may manage interactions between the useful life 115, reliability probability 160, subsystems 175, and repair work scope of the plant. For example, the simulator/optimizer may estimate system level reliability probability 160 at a point in time 105 by looking up the value of the reliability probability 160 at that point in time 105 along the useful life consumption path 140. The reliability probability 160 may be derived or simulated from engineering models and observation of fielded units, and corrected for climates, load cycles, transient dynamics, repair cycles, subcomponent vendor sources, metal temperatures, and other indicators and drivers that characterize the RUL 172. In various examples, the simulator/optimizer may retrieve the cumulative state information (e.g., operational paths 120 and 125, and useful life consumption path 140) from either a control system of the plant, a plant data store, or a remote data store of the operational history of the plant.

Further, as depicted in FIG. 1, the reliability probability 160 of the entire plant or system may be based on the RUL 172 of each of the subsystems 175 of the plant, and may be developed by one or more methods, such as, for example, statistical regression or subsystem models aggregated with techniques such as Monte Carlo simulation. Variation in RUL 172 forecasts may result from many factors, operations hours being one such causal variable as depicted in graph 100. In like framework, the simulator/optimizer may track other causal factors, such as component shutdowns, trips and starts, air cleanliness with respect to particles and chemical concentration, and metal temperature, from direct measure and/or virtual sensing of these factors as the plant is operated. Additional factors indicative of RUL 172, such as repair records, original equipment manufacturer (OEM), or OEM lot, may be operationally tracked and employed in the simulation or post processing.

Each major subsystem 175 that is important to the overall plant or system reliability probability 160 may be monitored and tracked. RUL 172, expressed as a probability 177 of two subsystems 173 and 176, is depicted in graph 100. As illustrated therein, for all RUL 172 estimates, the subsystem 176 is less reliable than subsystem 173, and thus the subsystem 176 is most likely to be the limiting component in the probability of life (reliability probability 160) for the overall plant.

The threshold of reliability risk from point 164 (e.g., no risk) to point 167 (e.g., near-certain impairment) may be a parameter employed in the simulator/optimizer. In the illustrative example of FIG. 1, the simulator/optimizer may determine a setpoint (e.g., particular reliability level 162) as the impairment risk limit and thus may request unit repair at approximately time 150 when the remaining useful life value 148 occurring along useful life segment 146 is attained. This setpoint (e.g., particular reliability level 162) may have been another point 166 along the reliability probability 160 if the economics or other metrics of value warranted operations with that risk level for the greater overall plant-level performance.

Moreover, the simulator/optimizer may beneficially estimate the value of a subsystem upgrade and/or repair by simulating the plant with life-limiting components, such as subsystem 176 of FIG. 1, with alternate available RUL 172 probabilities 177. Should the cost of upgrade or repair work scope of the subsystem 176 be adequately compensated by the economic gain produced at the plant level, the simulator/optimizer may provide a recommendation for the upgrade or specified repair work scope. Further, the simulator/optimizer may assess any number of candidate work scopes in providing such a recommendation.

FIG. 2 is a block diagram of a simulator/optimizer 200 configured to optimize various aspects of an industrial system (e.g., a power plant, such as the plant associated with FIG. 1) over one or more criteria for an economic lifecycle. For example, the simulator/optimizer 200 may be configured to manage operations, design, service, and control of a power plant 205 to optimize the economics and/or other aspects of value of the commercial business model that the power plant 205 provides using possible design, design modification, and/or control dynamics, as influenced by temperatures, pressures, and stresses of operation so that scheduled outages of the plant 205 are met such that that the useful life consumption of the plant 205 results in an optimized value for that consumption, subject to design reliability. In addition, the simulator/optimizer 200 may be configured to optimize the scope of repairs to the plant 205 by adjusting the operations and/or controls of the plant 205. Moreover, the simulator/optimizer 200 may manage relationships between plant usage, remaining useful life, and component/system health or reliability. Accordingly, the simulator/optimizer 200 may manage the operational path of the plant 205 in addition to other physical aspects of the industrial system, as well as the business-related operations of the plant 205, such as, for example, dispatching, lineups, bidding, and contracting, to optimize or enhance the total value, economic and/or otherwise, provided by the plant 205. The simulator/optimizer 200 may be used to assess the value of changing a system setting or constraint by manipulating one or multiple features of the design, operations, risk preference or desired system performance level. In some examples, the simulator/optimizer 200 employs stochastic multi-period evolutionary optimization for the plant 205 to perform the above functions.

In the example embodiment of FIG. 2, the power plant 205 that is simulated and optimized by the simulator/optimizer 200 may include multiple subsystems, such as one or more gas turbines, a heat recovery steam generator, a steam turbine, and so forth. In one example, the power plant 205 may be an actual, currently operating power plant 205 that is to be optimized or enhanced, such as by way of changes to subsystems or equipment, operation, maintenance, and the like, to improve the overall economic value of the plant 205 and/or the technical or physical capabilities of the plant 205. In another example, the power plant 205 may be multiple operating power plants to be optimized or enhanced. In another example, the simulator/optimizer 200 may be employed to optimize a planned, but as yet unrealized, plant that is proposed for subsequent operation in a particular geographic area, or for an intended owner, operator, or other place or person.

Inputs or factors that may affect or influence the power plant 205 and its operation include internal factors 210 that are, to at least some degree, under the control of the owner, operator, or other person or entity associated with the power plant 205. The internal factors 210 may include technical, physical, or business factors, such as, for example, the power plant 205 design, operations, availability, lineups, upgrades, maintenance, dispatch, capital equipment purchases, and so on.

The factors influencing the power plant 205 may also include external factors 215, which are factors not under the control of persons or entities related to the power plant 205. Examples of the external factors 215 may include, but are not limited to, environmental regulations, actions of competitors, weather, long-term fuel costs, and the financial costs in the capital markets.

During operation of the power plant 205, various aspects or values of the operating power plant 205 that characterize current operating conditions or states with the plant 205 may be captured as state data 207. The state data 207 may be captured by sensors or gauges located within the plant 205 in some embodiments. The state data 207, in some examples, may include temperature readings, pressure readings, flow rate measurements, and other data. Further, the state data 207 may be read or captured periodically, continuously, or according to some other schedule over time. Also, the state data 207 may also include repair and replacement records associated with components of the power plant 205.

The external factors 215, the internal factors 210, and the state data 207 are provided to the simulator/optimizer 200, and more specifically, to one or both of a plant condition analyzer 220 and a factor simulation engine 240. The simulator/optimizer 200, as shown in FIG. 2, may also include a criteria module 255 and an optimization engine 270, optionally also along with a data storage interface 265 and a user interface 260. In various examples, the simulator/optimizer 200 may be included within a single computing system or distributed among several computing systems, which may be communicatively coupled via a computer network, such as, for example, a local area network (LAN) (e.g., Ethernet or WiFi®), a wide area network (WAN) (e.g., the Internet), a cellular network (e.g., third-generation (3G) or fourth-generation (4G) network), or another communication network or connection. For example, one or more portions of the simulator/optimizer 200 may be implemented in one or more cloud-based computing systems available over the Internet or other WAN. In yet other examples, the simulator/optimizer 200 may be one or more supercomputer or parallel processing systems. Such systems may facilitate processing of multiple or numerous scenarios executed over extended simulation time periods to generate one or more possible configurations, lineups, operation and control plans, maintenance schedules and work scopes, and other characteristics of the power plant 205 to optimize output, revenue, and so on.

The data storage interface 265 may couple the simulator/optimizer 200 with one or more data storage devices 202, and the user interface 260 may couple the simulator/optimizer 200 with one or more user devices 201, by way of the same types of computer networks or communications connections mentioned above. Examples of the data storage devices 202 may include, but are not limited to, magnetic disk drives, optical disk drives, flash-based memory devices, and other types of non-volatile memory systems. Examples of the user devices 201 may include, but are not limited to, desktop computers, laptop computers, tablet computers, smart phones, and personal digital assistants (PDAs).

The plant condition analyzer 220 may receive any of the state data 207, internal factors 210, and external factors 215 to generate and/or teach one or more models employable for calculating operating efficiency, remaining useful life, and other information describing the state of the power plant 205 based on the received data. In the example of FIG. 2, the models may include one or more of a physics-based model 25, such as a thermodynamic heat balance, and a data model 230, such as a neural network. In some examples, the physics-based model 225, the data model 230, or both may track or determine over time the health and operating condition of the power plant 205 and its various subsystems or components. Further, the data model 230 replicates and augments physics-based model 225 for predicting the Heat Rate of the power plant 205. In some examples, models 225 and 230 may facilitate data reconciliation, sensor fault detection and accommodation. Additionally, the models 225, 230 may calculate the operating efficiency, remaining useful life, and other information describing one or more states of the power plant 205, which may then be made available to an optimization engine 270, possibly by way of the criteria module 255, to investigate one or more scenarios regarding the operation and use of the power plant 205. In some examples, thermodynamic data of the power plant 205 can be combined with real plant data for training the data model 230 to replicate all components of the power plant 205.

A second component being supplied with any or all of the state data 207, internal factors 210, and the external factors 215 is the factor simulation engine 240, which includes an internal factor simulator 245 that may produce actual or simulated information describing the design, operations, reliability and other internal factor information associated with the power plant 205, such as temperature readings, pressure readings, flow rate measurements, and the like. The factor simulation engine 240, as shown in FIG. 2, may also include an external factor simulator 250 that generates actual or simulated information describing various physical, technical, and/or business external factors influencing the power plant 205, such as environmental regulations, actions of competitors, weather, long-term fuel costs, and the financial costs in the capital markets. In one example, internal factor simulator 245 may simulate the internal factors using random walks of factors ahead of real time. As history unfolds, internal and external factors 210, 215 being simulated by the internal factor simulator 245 and the external factor simulator 250 may he replaced with at least some of the actual state data 207, internal factors 210, and/or external factors 215 being received from, or being imposed upon, the actual power plant 205. Further, some or all of the various state data 207, internal factors 210, and external factors 215, whether actual or simulated, may be stored via the data storage interface 265 to one or more data storage devices 202 for later retrieval in subsequent scenarios investigated in the optimization engine 270.

The criteria module 255 may be configured to generate one or more criteria such as a candidate system configuration, setting or preference under which the optimization engine 270 is to perform its optimization. For example, the criteria module 255 may provide possible value, parameters, or limits regarding various factors (e.g., state data 207, internal factors 210, and external factors 215, whether actual or provided via the plant condition analyzer 220 and/or the factor simulation engine 240) to be employed by the optimization engine 270 in performing its optimization operations. For example, the criteria module 255 may set specific data relating to financing the plant 205 (e.g., purchase or lease, the amount of funds available for financing, etc.), the type and configuration of subsystems or equipment that may be employed in the plant 205 (e.g., the number and types of gas turbines, how the turbines may be coupled, etc.), the timing and scope of maintenance to be performed (e.g., the minimum time between maintenance events of the turbines, etc.), the expected weather in the vicinity of the plant (e.g., the maximum and minimum temperatures expected at the plant 205 over particular time periods, etc.), and so on. As indicated above, such information may be simulated data or actual historical data from the power plant 205.

In addition, the criteria module 255 may generate the criteria based on input received from one or more user devices 201 via the user interface 260 of the simulator/optimizer 200. For example, a user may impose specific limits or ranges on any state data 207, internal factors 210, and/or external factors 215. For example, the user may set upper limits on the cost and financing of the power plant 205, set minimum time periods between maintenance of particular subsystems of the power plant 205, limit particular sources of subsystems to particular vendors, limit the number of particular types of components or subsystems to be used, limit the amount of useful remaining life of the power plant 205 that may be consumed during particular time periods, specify allowed loads on the plant 205, and so on. The user may also set particular time periods (times of year, lengths of time, etc.) over which the optimization engine 270 is to investigate the operation of the power plant 205. The system may substitute settings provided by users with directed inputs used to explore design or operations capabilities or to calculate the slack value when system parameters are acting as constraints.

The various simulated or acquired internal factors, external factors, state data, and other information from the plant condition analyzer 220, the factor simulation engine 240, and/or the data storage devices 202, as filtered or massaged via the criteria module 255, may be forwarded to the optimization engine 270. The optimization engine 270 may then simulate the operation of the power plant 205 by executing multiple scenarios simulating the power plant 205 over some designated period of time, and over various values of the factors (e.g., system designs, maintenance periods, expected loads, etc.) to generate simulation/optimization results 275 of the overall performance of the plant 205, the useful life of the plant 205 consumed, the overall return of investment of the plant 205 (e.g., taking into account financing of the plant 205, fuel costs, the possible grid market pricing, and so on), and other information based on variations of the criteria received from the criteria module 255. In at least some embodiments, the optimization engine 270 may perform thousands or millions of simulations to cover many or all of the possible permutations of the various criteria provided by the criteria module 255.

Further, the optimization engine 270 may determine which design and operating choices, maintenance schedules, financing options, overall cash investment, and the like specified via the criteria are likely to provide better outcomes in terms of return on investment or other measures of economic value, or other types of value, such as, for example, compatibility of the power plant 205 design relative to other power plants 205 or systems working in tandem with the power plant 205. In some examples, the optimization engine 270 determines optimized results by comparing results of multiple executions over different criteria and by selecting one or more of those executions that represent increased measures of economic value mod/or some other value metric. In at least some example systems, the optimization engine 270 may trade off multiple criteria over one or more time intervals and enable the business-physical system of the power plant 205 to evolve over time, subject to the constraints of a given one or more periods.

The simulation/optimization results 275 may include the physical and business-oriented aspects discussed above (e.g., overall performance, useful life, overall return on investment), along with the input data that define the scenarios used to perform the various simulations and optimizations. In one example, the simulation/optimization results 275 may be made available for viewing on the user devices 201 via the user interface 260. In some embodiments, the simulation/optimization results 275 may be stored in one or more of the data storage devices 202 for subsequent comparison by the optimization engine 270 with other, more recent execution runs, and for future access via the user devices 201 and the user interface 260.

In some embodiments, the optimization engine 270, as well as other portions of the simulator/optimizer 200, may be contained in a control system of the power plant 205 or a computing system operating on premises that are associated with the power plant 205, such as a supercomputer or a parallel processing system. In other examples, the optimization engine 270 and/or the simulator/optimizer 200 may be located in a shared service, such as a fixed or elastic cloud-based computing system.

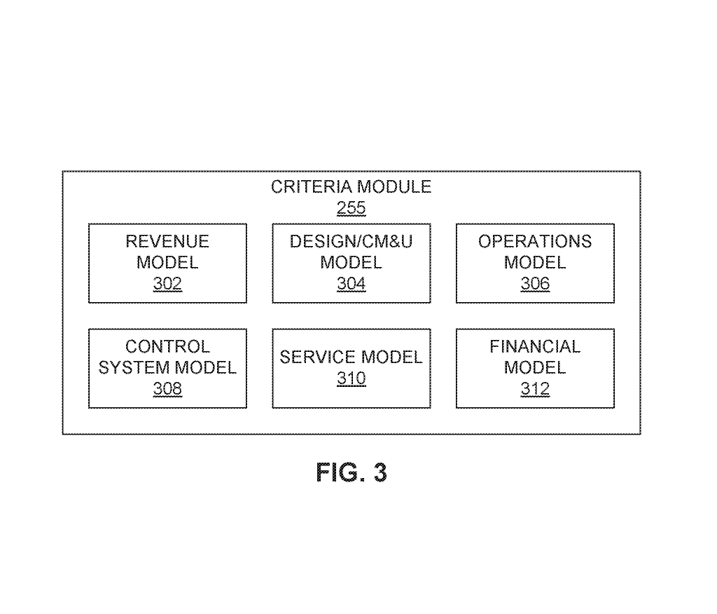

In one embodiment, the criteria module 255 may include one or more models that specify or provide the various inputs, limitations, and other criteria described above that may be employed in the simulations and optimizations executed by the optimization engine 270. To that end, FIG. 3 is a block diagram of the criteria module 255 of FIG. 2, in one embodiment. This example of the criteria module 255 includes a revenue model 302, a design/custom modifications and upgrades (CM&U) model 304, an operations model 306, a control system model 308, a service model 310, and a financial model 312. While FIG. 3 provides for six particular models 302-312, other embodiments may employ fewer or greater number of models, each of which provides similar or different information relative to the models 302-312. Further, the information provided in each of the models 302-312 may be based on the state data, internal factors, and external factors discussed above, as well as on user input.

Referring to FIG. 3, the revenue model 302 may be configured to provide criteria regarding the monetary aspects of operating the power plant 205, including the revenue generated by the plant 205, the costs of fuel that may be used to operate the plant 205, dispatch and trade parameters, power generation capability and grid stability expectations, and so on. For example, the revenue model 302 may provide possible terms of power purchase agreements, possible ways of generating revenue from waste heat and/or other byproducts of the plant 205, electricity spot pricing, desired profit margins, and the like.

The design/CM&U model 304 may be configured to provide particular design options, such as alternatives regarding the particular subsystems (e.g., gas turbines) and components of the power plant 205. The design/CM&U model 304 may also be configured to suggest custom modifications and upgrades to a pre-existing design of the power plant 205 that may result in enhanced return on investment or other aspects of value. Further, slack values are calculated by relaxing constraints which are characterized by system design or operating policy points.

The operations model 306 may be configured to provide one or more sets of policies or rules regarding operation of the power plant 205. In one example, such policies may be set based on information received at the operations model 306 from the physics-based model 225 and/or the data model 230 of the plant condition analyzer 220. In other embodiments, the physics-based model 225 and/or the data model 230 of the plant condition analyzer 220 may serve as the operations model 306 within the plant condition analyzer 220, as opposed to being located within the criteria module 255. Example policies may include circumstances under which the plant 205 may exceed its normal steady-state ranges (and for how long), circumstances under which the plant 205 should be shut down, weather conditions under which certain components (e.g., an inlet chiller) should be employed, and so on.

The control system model 308 may be configured to provide parameters, limitations, and the like regarding the operation of particular subsystems (e.g., gas turbine) or components of the power plant 205. For example, the control system model 308 may provide information regarding allowable inlet schedules and other parameters for ramp up of a component in response to increasing load, how much remaining useful life may be consumed by overfiring a component by a specific period of time, and so forth. Such information may be useful in determining whether operating the component such a manner may be useful in generating additional revenue.

The service model 310 may be configured to determine various parameters and limitations regarding the servicing, repair, and/or replacement of the various components and subsystems of the power plant 205. Such parameters may include the particular types of repair to be performed on a particular component based on the amount of use of the component, limitations regarding the use of the component that may invalidate a service contract or warranty, the length of time associated with the repair and/or replacement of the component, and the like. The costs of different potential service contracts and their various terms may also be provided.

The financial model 312 may be configured to provide different scenarios regarding various financial aspects of the power plant 205 that may be considered. In some examples, the financial model 312 may provide different scenarios regarding capitalization of the plant 205, such as whether the various components of the plant 205, or the plant 205 in general, may be purchased using presently available funds, whether outside investors may be pursued, whether financing should be employed, and so on. The financial model 312 may further analyze cash inflows and outflows based on initial investments, repair and/or replacement of components, cost of fuel consumed, expected revenues based on market pricing for output of the plant 205, and the like. Moreover, the financial model 312 may provide indications of equity risk/return preferences of the owners and/or operators of the plant 205, as well as the lifecycle economic dispatch, modification, operations, and services that may achieve such preferences, subject to various capital structure constraints.

While FIG. 3 indicates that each of the models 302-312 may be located within the criteria module 255, one or more of the models 302-312 may be located within another module of the simulator/optimizer 200, or separately within the simulator/optimizer 200.

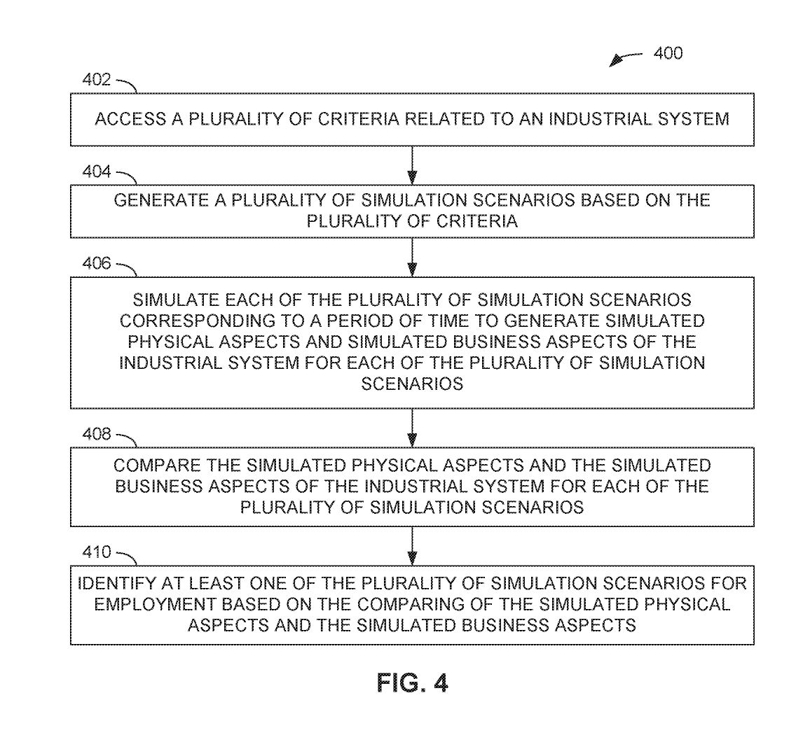

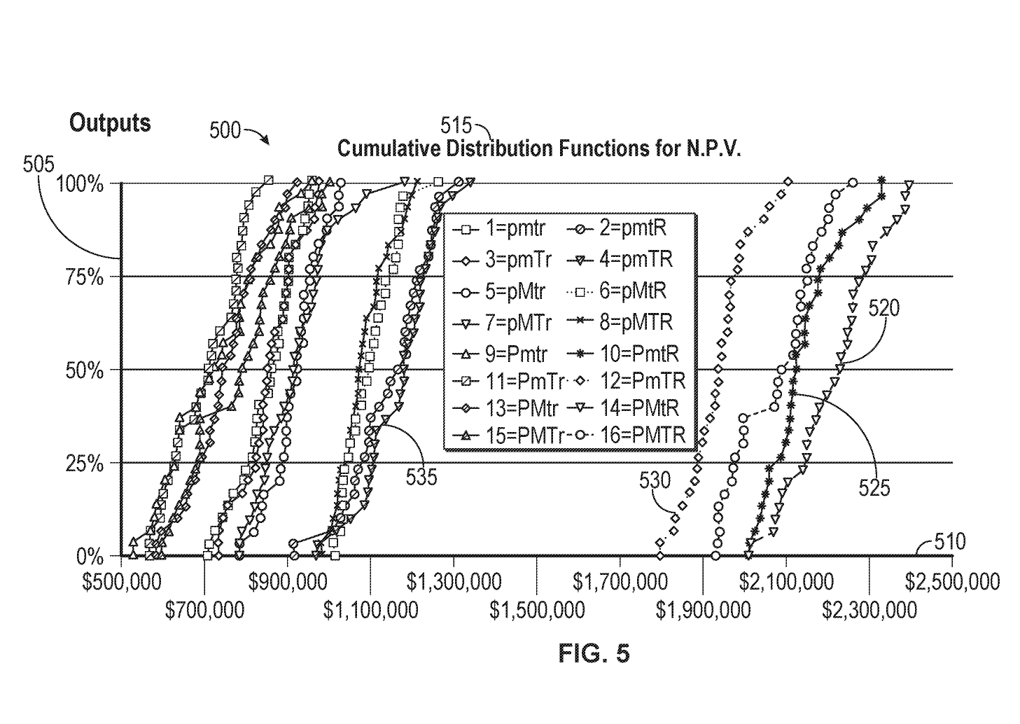

FIG. 4 is flow diagram of an example method 400 of physical and business optimization of an industrial system, such as, for example, the power plant 205. While the method 400 presumes the use of the simulator/optimizer 200 of FIG. 2, other devices or systems capable of performing the various operations of the method 400 may be employed in other embodiments.

In the method 400, a plurality of criteria (e.g., criteria generated at the criteria module 255) to be applied to an industrial system (e.g., the power plant 205) may be accessed (operation 402). For example, the plurality of criteria may include criteria relating to the possible design, modifications and upgrades, operations, control systems, service schedules, revenues, and financial costs associated with the industrial system, as discussed earlier. In some embodiments, at operation 402, the criteria module 255 may further define one or more assumption criteria for design and operations evaluation with respect to a baseline and/or for a comparative scenario assessment.

Based on the accessed plurality of criteria, a plurality of simulation scenarios may be generated (operation 404). In some embodiments, one of the criteria may be varied within some specified or acceptable range or set of values to produce a new simulation scenario. Systematic alteration of the criteria in such manner may result in thousands, and possibly millions, of different simulation scenarios.

Each of the simulation scenarios may then be simulated (e.g., by the optimization engine 270) to generate simulated physical aspects and simulated business aspects of the industrial system for each scenario (operation 406). For example, the optimization engine 270 may execute each simulation scenario over some simulated time period. The physical aspects may include, for example, information regarding how the useful life of the industrial system, or components thereof, is consumed over the simulation period, the costs of operating the industrial system, the resulting benefits from operating the industrial system in such a manner (e.g., economic return on investment in the industrial system, the role the industrial system plays within a group or network of a plurality of industrial systems), especially compared to any risks involved in following this particular scenario, and so on.

The simulated physical aspects and the simulated business aspects of the industrial system for the simulation scenarios may then be compared (operation 408) by the optimization engine 270. For example, the optimization engine 270 may compare the economic return associated with a particular scenario in light of the resources (e.g., monetary resources, physical resources of the plant 205, and so on) against the corresponding return provided by other scenarios to determine its relative benefit to the owner, operator, or other entity related to the plant 205. In addition, the economic return for a particular scenario may be compared to, or balanced with, any economic or other risk associated with that scenario. For example, among two scenarios that provide essentially the same benefit and expense but different levels of risk, the optimization engine 270 may consider the scenarios associated with the lesser risk to be a more beneficial or a desirable scenario. Based on these comparisons, the optimization engine 270 may identify at least one, and possibly several, of the simulation scenarios for employment in the power plant 205 (operation 410) and may be configured to manually or automatically implement them in the control or operations system(s) of the plant or within the administrative business processes or outage work scope.

While FIG. 4 depicts the operations 402-410 of the method 400 as being executed serially in a particular order, other orders of execution, including parallel, concurrent, or overlapping execution of one or more of the operations 402-410, are possible. The simulation of each scenario (operation 406) may be performed in an overlapping, parallel, or concurrent manner on different processors or processing threads. Moreover, the generation of the simulation scenarios (operation 404), the simulations of the plurality of simulation scenarios (operation 406), and the comparing of the resulting simulated aspects (operation 408) may be performed in an overlapping manner as well. Remaining methods described in greater detail below may be interpreted similarly.

FIG. 5 is a graph 500 illustrating the possible economic results associated with each of a number of scenarios 520, 525, 530, and 535. In the graph 500, the probability 505 of a particular outcome or result of the simulation of each of the multiple scenarios 520, 525, 530, and 535 is plotted against its resulting economic return 510 (e.g., cumulative distribution percentiles 515 for a net present value (NPV)). In other embodiments, other measures of economic value, utility, or return may be employed in lieu of NPV. In some examples, each simulation scenario and its replications which capture variation may consider multiple system designs, path switching options, and operations tradeoffs over a forecast time interval that calculates the probability 505 of achieving a particular economic return 510 (or other KPI or metric of value). More specifically, many possible operational, physical design, and contractual choices, as well as the exogenous factors these industrial systems are typically exposed to, may be simulated to produce cumulative distribution percentiles 515 of the cash flows yielded by the simulated industrial system for the many combinations of contractual, design, operations, control, service, and capital structure choices to be explored.

For a given scenario corresponding to a particular combination of system design, power sale contract term, maintenance guide, operating principles, control policy, and/or other factors implemented in a given time sequence, or transitioned in the simulation at a certain state (e.g., immediately after a repair), multiple series of exogenous or external factors may then be generated, allowing the optimization engine 270 to direct the simulation of the operation and associated economic return of the industrial system for that scenario over a given time period. Replications of a specific scenario may be run against exogenous factors such as, for example, weather factors (e.g., temperature, relative humidity, and atmospheric pressure), market pricing of inputs (e.g., fuel), and output values (e.g., heat rate of the industrial system). These replications may then be utilized to create a histogram that is subsequently integrated mathematically to form a cumulative distribution, which may then be plotted as particular scenarios 520, 525, 530, and 535.

The combination of designs, operations, contracts, and settings in the simulation may produce different risks and returns. As shown in FIG. 5, scenario 520 may produce a higher economic return 510 than scenario 535 across all probabilities 505. In some example, risk may be defined as the certainty or probability 505 of a particular economic return 510 and may be characterized as the slope of the scenario-to-scenario output, the average slope of a scenario with replications, or just a portion of the replications such as at the expected value (e.g., at the outcome of the fiftieth percentile, over a range at the fiftieth percentile plus-or-minus one standard deviation, and so on). As shown in FIG. 5, scenario 520 generally produces a higher expected economic value than scenario 525. However, a significant portion of scenario 520 and scenario 525 produce similar outcomes over their probabilistic ranges, whereas scenario 530 is inferior to both scenario 520 and scenario 525 over all probabilities, but superior to scenario 535.

Economic optimization may be performed across a defined period of time. At a particular instant of time, the effect of actions an industrial systems operator can perform regarding plant or apparatus lineups, assignments, and set points, in addition to policy decisions regarding major service work scope, served market, and capital structure, may determine and dominate the economics of an industrial system. A practical challenge for decision-makers and stakeholders is to identify and understand the economic ramifications of short-term and long-term choices in operation, design, service, and capital structure and robustly choose the optimal design or operations policy. Short-term choices, such as how hard an industrial system is cycled, accelerated, fired, and no on, can, over time, degrade the materials, strength, and life consumption of the assets of the industrial system. Further, constraints such as environmental limits may be reached earlier than anticipated, or maintenance timing and/or work scope to maintain efficiency and/or reliability of the industrial system may be affected. The possible number of combinations of short-term and long-term operating policy, design, service, and finance scenarios may easily reach into the millions. The variation of each scenario, depending upon factors within and external to the control of the stakeholders of the industrial system with respect to operations, design, service, and exogenous factors (e.g., fuel costs, changes in regulations, market interest rates, and competitors' actions), can create a wide variation in economic results from one scenario to the next.

Another practical challenge to understanding industrial system-level risk and return is the perspectives of various stakeholders, who typically are experts in their corresponding components of the business and physical system and provide the disclosed decision support which reconciles each stakeholder's responsibility and objectives with the overall plant performance. For example, a plant operator may appreciate the reliability effects of certain operations, and the resulting maintenance actions caused thereby, that a dispatcher may not. However, the dispatcher may appreciate the extreme financial benefit a certain plant output may have due to a market condition that a person responsible for efficiency and operating risk reduction may not. Further, engineering personnel may not appreciate the contractual terms of an OEM service agreement to the extent an asset manager may.

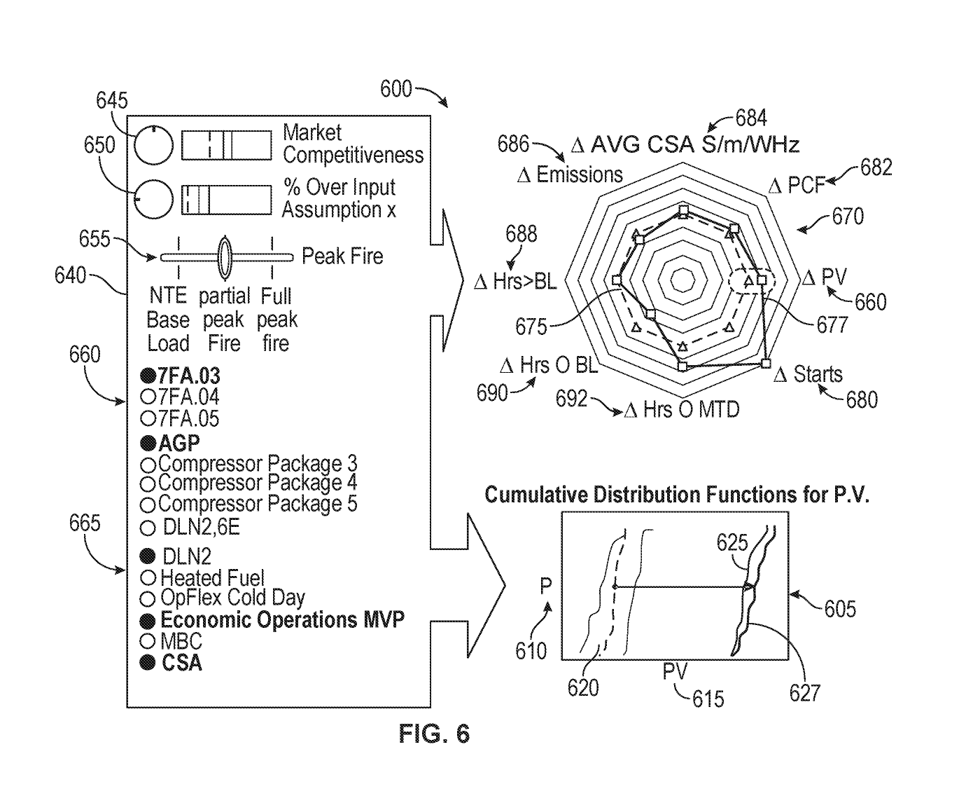

An example of a way to bring combinations of operations, design, service and finance, short and long-term decisions, plant and central operations together may be a decision support interface 600 for economic optimization, as depicted in FIG. 6. The financial risk and return, represented in one example in a cumulative distribution function for each of multiple scenarios in a present value graph 605, may be based on a set of scenario inputs 640 specifying various operations, design, service, and financial choices, and the physical and business system key performance indicators, along with their comparative changes, as exemplified in an example “spider” graph 670. In some examples, a number of “what if” questions or scenarios that are either manually proposed by decision-makers or generated via an optimization algorithm may be readily configured and understood via the decision support interface 600. The interface 600, in a number of some embodiments, may configure a simulation setup, or may recall prior simulated results from a repository data environment. In at least some embodiments, the interface 600 aids the user in discovering one or more scenarios that may raise the economic value of an industrial system while, if possible, reducing the associated risks. To that end, the present value graph 605 may provide the probability 610 over a significant number or range (e.g., thirty or more replications or iterations) of present value (PV) 615 or a net present value (NPV) of cash flows over a selected forecast time period for each of a number of scenarios. Example output provided via the decision support interface 600, such as in the form of the present value graph 605, may enable the characterization of the “as is,” or base case 620, business-physical industrial system (also termed a “system of systems”) in terms of its risk and return. Further, if feasible, the interface 600 may present more economically viable operating points, design, maintenance, and financial structures, such as those described by the combination of decisions leading to scenarios 625 and 627, each of which produces a greater PV 615 or NPV compared to the base case 620.

More specifically, the present value graph 605 indicates that base case 620 is economically dominated, across all probabilities, by scenarios 625 and 627 when the PV 615 (or NPV) is the economic measure being considered. Further, the two scenarios 625 and 627, across a significant confidence interval, are not economically differentiated from each other even though the expected value at the fiftieth percentile probability of scenario 627 is higher than that of scenario 625. Such insights may enable better capital allocation decisions from a criteria of an economic return and risk.

In one example, a scenario is a configuration of the physical industrial system, a set of operations and maintenance policies for that system, an indicator of the market competitiveness of the system, terms of service to maintain the system, and/or financial contracts for financing the system. These inputs are then subjected to simulated exogenous variables, such as fuel cost and weather factors, to calculate pro forma assumptions, as described above. Scenario inputs 640 may enable easy-to-select options for either a human in the loop and/or an optimization engine, such as the optimization engine 270 of FIG. 2. Examples of the scenario inputs 640 may include the market aggressiveness or competitiveness 645 involving the industrial system, the allowed exceedances 650 on baseline operating points, allowed physical life consumption 655 from highly sensitive operating points, the type of assets 660, and available design modifications and upgrades 665 available for consideration.

Performance indicators for industrial and business systems may be multidimensional. As a result, multiple such indicators may be presented by way of an output “spider” graph 670 in one example. With respect to a power generating asset, key indicators can include a number of systems starts 680, operating hours 692 at minimum load, operating hours 690 at baseload, operating hours 688 above baseload, emissions 686, service cost 684, change in any input cost or quantity or pro forma cash flow (PCF) 682 at any point or span of time. As shown in FIG. 6, the various key indicators for each of a number of scenarios may be graphed and compared, such as for the base case 620 (shown as plot 675) and scenario 627 (shown as plot 677). Any operating value, input, or figure of merit may be reported, tracked, and calculated in other embodiments. These key indicators may also include constraints in the system, such as emissions limits, specific terms in a service contract, or financial covenants in a capital structure. Importantly, the physical system's design and operations policy may be directed by a control system enabled with the disclosed optimization engine to change over time or to create an option to change, and the resulting performance calculation will accurately reflect the absolute, comparative and conditional value. Also shown in the graph 670 may be the NPV or PV 615 (depicted as assets 660 in the spider graph 670) of one or more scenarios. A typical objective is to increase the NPV or PV 615 (or assets 660) when no capital investments are needed to enhance value creation and/or reduce risk.

In various embodiments, evolutionary multi-period risk and return management of an industrial system may be facilitated. The benefits resulting from such management may include optimal realization of positive economic outcome creation in view of the particular investor or owner's risk tolerance. Further, surplus returns from base case (e.g., non-optimized) operations, should they be realized, may provide future investment that further enhances economic vitality. The owners of engineered industrial systems and the business processes that use and consume those systems typically possess different risk and return preferences resulting from the industrial systems being at different points in their economic lives. For example, a new industrial unit may be associated with a preference for debt repayment, while a fully depreciated unit may provide significant upside return potential if the operating constraints on that unit are expanded.

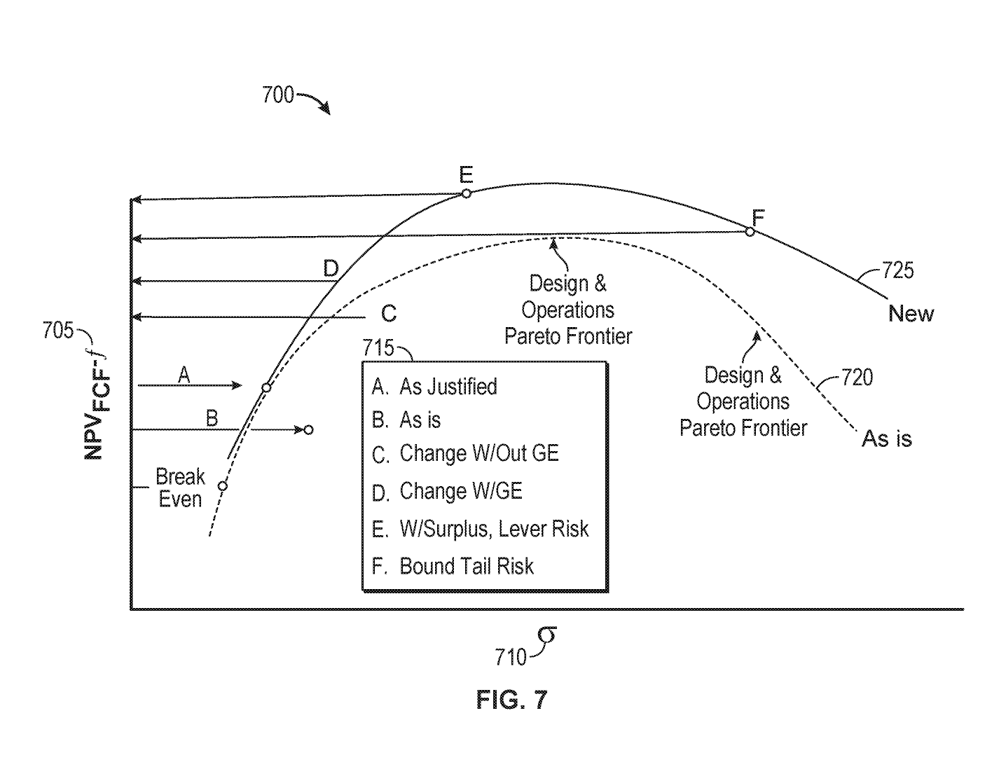

FIG. 7 is a graph 700 that displays aspects of the performance of an industrial system relative to the preferences of the system owners and the entitlement of those industrial systems to change their risk and return relationships. Two dimensions are displayed in the graph 700. A first dimension represents the net present value (NPV) 705 of the free cash flows (FCFs) discounted at a risk-free interest rate over the economic optimization forecast interval. This NPV 705 is calculated via a pro forma whose assumptions are being provided by the system of systems simulation. The second dimension is variation 710. This variation 710 represents the periodic differences of the free cash flows of the industrial system.

In the graph 700, two curves are depicted that describe or frame the financial entitlement that may be enabled by aspects of the disclosed inventive subject matter. A first curve describes the “as-is” or base case 720 Pareto frontier of risk and return relationships for the given industrial system as it is currently designed, operated, or constrained. The second curve signifies the “could be” or “to be” 725 Pareto frontier, whose improved capacity to generate higher economic returns at a given level of risk than the base case 720 is enabled with new design and operations capability, as determined by the simulation and optimization operations described above, such as those associated with the simulator/optimizer 200 of FIG. 2. Generally, a Pareto frontier may identify a set or range of parameter values representing an optimized result (e.g., in this case, NPV 705) for a given set of constraints.

Overall, six different risk-and-return relationships are plotted in FIG. 7, although more or fewer such relationships may be plotted in other examples. These relationships are significant indicator points with respect to achieving the financial objectives and risk tolerances of the owners of the industrial assets. Point A is the economic return, and the risk to achieving that return, of the original industrial system justification. Point B denotes a current state of the system which, in the example illustrated, has a lower NPV than the justified system and incurs more variation or risk associated with this state, and thus is not as economically vital as the system is capable of being. Such higher risk and/or lower return may be a result of an exogenous condition, such as a competitor or a technology substitute or perhaps as a result of its design and operation in the current or forecasted exogenous conditions or as a result of the operators of the industrial system not running the industrial system to its designated policy. This diminished state may also exist because the industrial system has not been beneficially re-engineered and optimized, as is possible via the simulator/optimizer 200 of FIG. 2. Point C is a new economic operating point that is perhaps achievable without the disclosed system, if there were manual co-optimization. Point D represents a beneficial change to the system that is compatible with the owner's risk/return preference that may be achievable via the ability of the simulator/optimizer 200 to find optimal design and operating policy points. Point E is a point of risk and return available for owners that are willing to experience periodic cash flow swings resulting from taking on more operational risk. The incremental resulting NPV creation may be a means to create a surplus that may then be invested into the system in a given operating period or over a sequence of operating periods spanning years. Alternatively, financing or cash outlay may be employed to migrate the system to higher returns for a given level of risk. Point F is a theoretical point which is established as a cap to loss. The simulator/optimizer 200 may enable this point's Put Option value to be calculated. A beneficial aspect of the simulator/optimizer 200 may be that a single customer may experience excessive risk and is willing to hedge that risk, while the OEM may offer services solutions that control for their contracted performance outcome, and may pool this risk amongst a portfolio of plants, thus providing a real option value to up-rate the plants in some way to reduce risk.

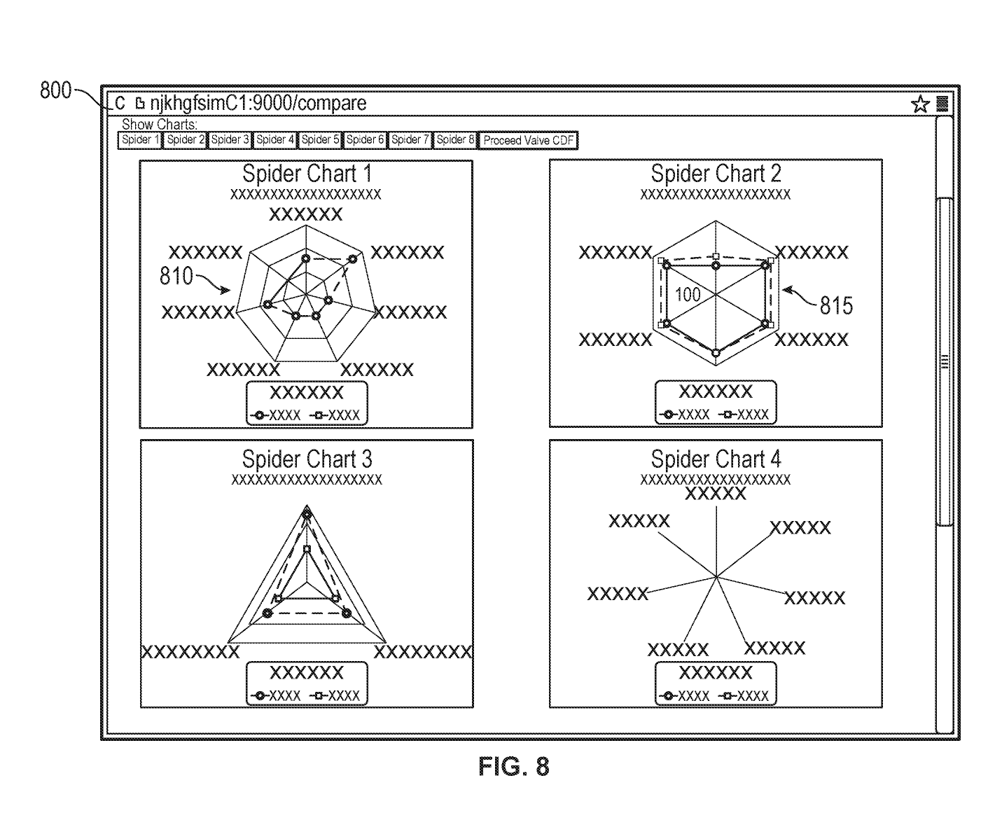

FIG. 8 is a graphical representation of an example user interface 800. Various aspects of value, or operating parameters or constraints, may be depicted on multiple views or “tiles,” which may be served from an analytical computing infrastructure that hosts simulator/optimizer 200, which may execute various simulation and optimization algorithms, as described herein.

In some examples, the tiles of the user interface 800 may be configurable so that particular key process indicators of the industrial system and its business processes may be presented and easily understood. In some instances, the changes which are available to be made in the industrial system result in no change to the key process indicators from the base case to the optimal new case, as is depicted in tile 810. Along other dimensions, the industrial system may be improved, as is depicted on tile 815, wherein the base case is dominated by anew case or scenario that the simulator/optimizer 200 has discovered via simulating a virtual version of the industrial system's physics based on data-derived models and its many sub-processes and their decision support.

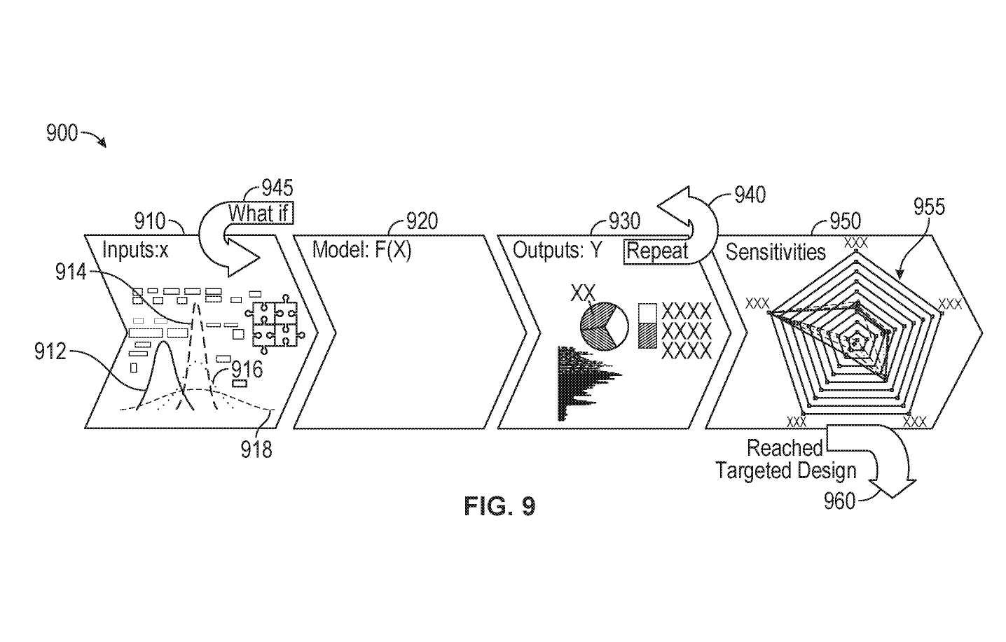

FIG. 9 is a flow diagram of an example data flow 900 of the simulator/optimizer 200 of FIG. 2. Generally, the data flow 900 represents the simulation of an industrial system with multiple replications over a set of possible scenarios. In the data flow 900, a modeling stage may receive or access a set of inputs 910, and a model 920 may execute using those inputs 910 to generate or calculate outputs 930. An inner iteration loop 940 may be formed using the outputs 930, possibly in addition to new inputs 910, to generate more outputs 930 for varying circumstances. The outputs 930 may also be post-processed to generate sensitivities 950, such as may be displayed in one or more spider graphs 955 or other output displays, as discussed earlier.

In various examples, the inputs 910 may be endogenous and exogenous assumptions, as discussed above. Some assumptions, such as, for example, heat rate or efficiency, may be composite distributions 918 of individual distributions 912, 914, and 916, each of which may have special causes that, if understood, enable a more accurate overall input forecast. An illustrative example is a very narrow efficiency forecast at a rated operating point versus a part load operating point with high sensitivity to exogenous conditions, plant line ups and control settings. The simulator/optimizer 200 may identify how assumptions and outputs 930 can be made more precise for risk reduction and beneficially shifted for value creation, with that value being economic in nature or some other figure of merit.

A “what if” or configuration input 945 to the model 920 may be a scenario configuration. Inputs 910, which define all aspects of the industrial system, such as its revenue model, design, operation, control, service, and capital structure, along with its constraints and objectives, may be tested by the simulator/optimizer 200 to uncover more beneficial designs and policies.

The system model 920, in one embodiment, may be a discrete event simulation that orchestrates all of the subcomponent models that span business and physical systems, calculating the key process indicators for a run over its economic lifecycle, and provides results for post-processing sensitivity and optimization. In another embodiment, the system model 920 may be an agent-based simulation with autonomous subsystems communicating and goal-seeking ideal business and physical system design and operations.

Model outputs 930 may be employed to assess objective satisfaction and create data for the post-processing of the outputs 930 so that comparative results and sensitivities 950 may be displayed in a graph 955 or other visual tool. When criteria have been robustly met from configuration input 945 to produce comparatively superior outputs 960, the simulation-optimization run may be terminated.

Typically, a complex industrial system is more than a single asset, and its constituent parts are operated according to the rules and policies of the business and/or physical subsystems discussed earlier. In some embodiments, these business and physical systems may be orchestrated together in a numerical simulation so that their interdependencies are made explicit, and so that an economic and/or other definition of value can be co-optimized for a selectable period of time. Further, this ecosystem's constraints may be quantified at the overall “system of systems” level so that the option value of changing those constraints is determined using the simulator/optimizer 200 of FIG. 2.

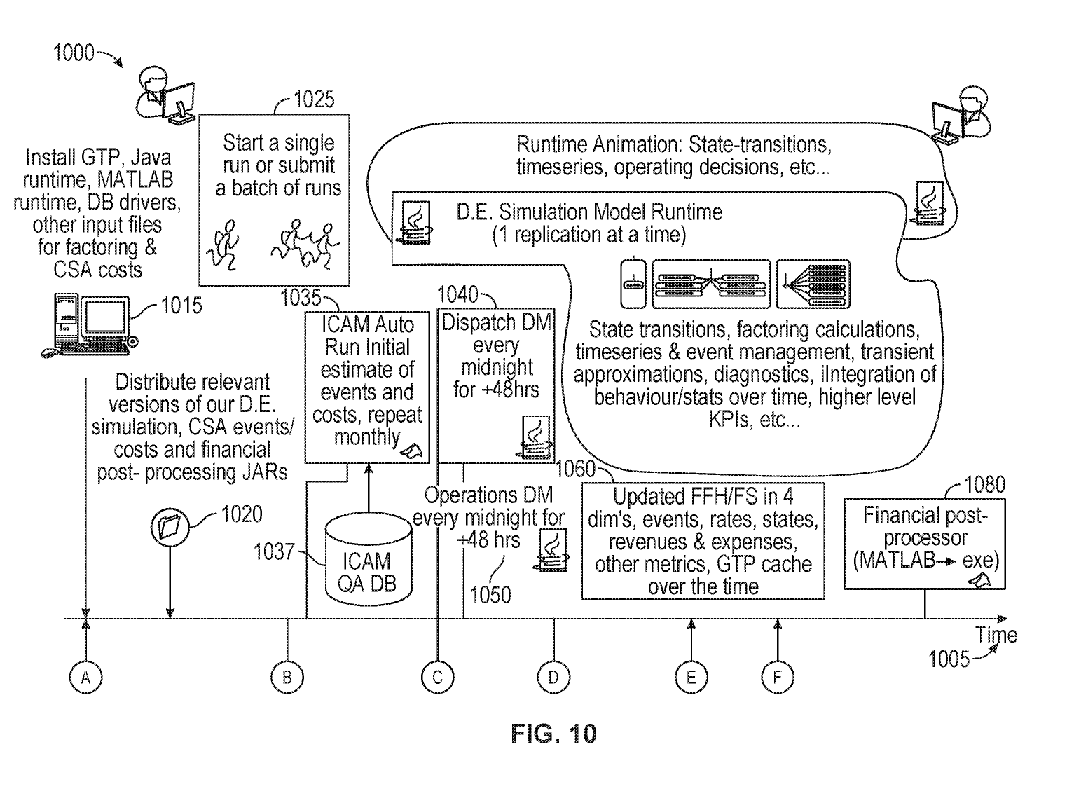

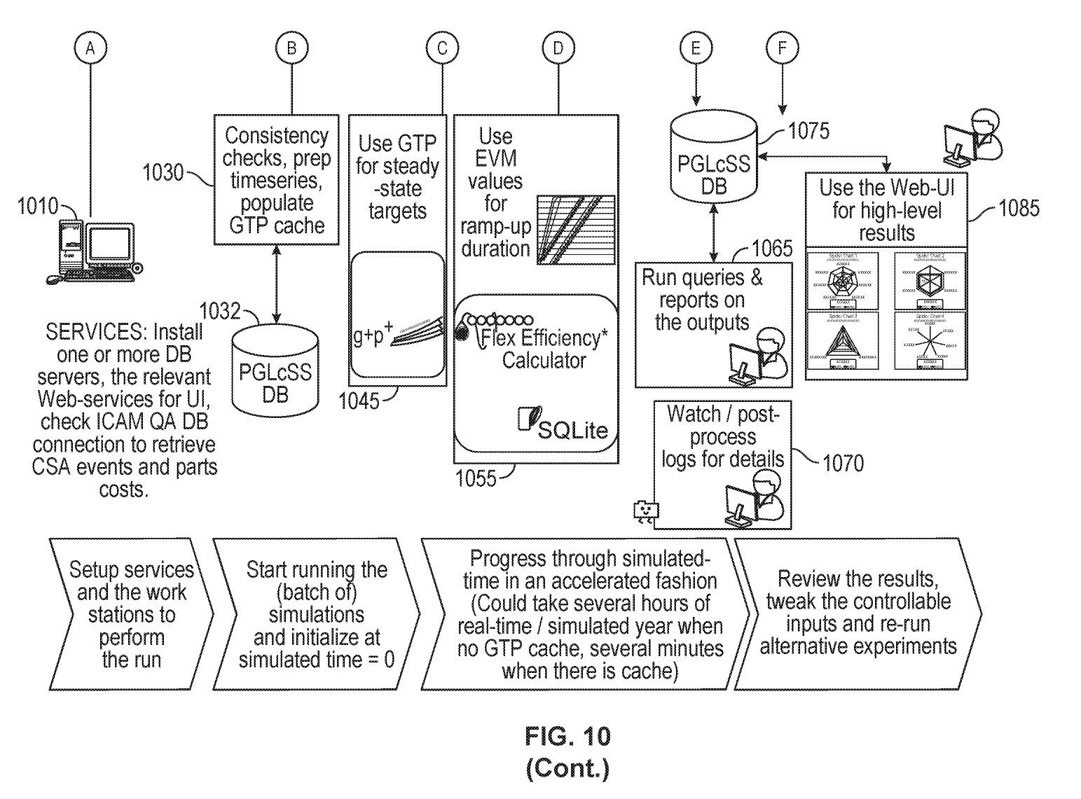

FIG. 10 is a time-based diagram of an example simulation 1000 of a complex engineered industrial system with corresponding business processes, contractual terms, and capital structure. In this particular example, the industrial system is a gas turbine combined-cycle power plant. Example industrial systems capable of being simulated and optimized in other embodiments include, but are not limited to, wind farms, distributed-generation electrical grids, rail operations, health delivery systems, air transportation networks, oil and gas extraction and production operations, manufacturing and supply chain systems, as well as other complex systems with physical assets, operational and maintenance contract and regulatory limits, capital structures, and personnel, and whose coordinated design, re-engineering, operations, maintenance, and financial performance may benefit from a co-optimized ecosystem of systems over one or more time horizons of interest for one or more business and/or operational objectives that are subject to factors beyond the control of the overall system.

The simulation 1000 may be performed over one or more simulated intervals of time 1005. Using observed data produced during actual operation of the systems over one or more previous time periods, the behaviors of the systems, as well as the exogenous forces they were subjected to, and the physical designs and operations policies that were implemented, may be determined. Further, at the current point in time 1005, the system-of-systems may produce data output and performance results which may or may not achieve the goals of the overall ecosystem. Current operating decisions are typically informed by the current state of the overall system according to a predetermined policy or control set. A future time period of interest may be the next instant, work shift, day, month, year, or more. Within each such time horizon, various system objectives of some economic or other benefit may be achieved through the design and operations of the system. Further, there may be multiple such time horizons of interest, such as, for example, a current state of the system and its current entitlement, from which the system is to perform according to a set of criteria to achieve a goal within a current financial, contractual, or regulatory period, as well as within subsequent time periods.

In at least some embodiments, the simulation manages and/or tracks an operational or performance path (e.g., the paths 125 and 140 explained above in conjunction with FIG. 1), such as by way of physics-based simulations. Further, those simulations may be combined analytically with the integrated subsystems with contractual terms in service maintenance and warranties, financing covenants, controls setpoints, and coordinated operations with other assets and processes in the ecosystem to explore new design and operating points, co-optimizing for one or more operational and/or business objectives. To that end, real (e.g., past and current states of the system) and simulated (forward or future) data describing the design, life consumption, efficiencies, operations (assigning/committing the overall system while maintaining regulatory compliance, performance levels, financials and other “business system” characteristics) and exogenous conditions (weather and fuel being examples) may both be employed to simulate and optimize the overall system.

The system-of-systems simulation 1000, as embodied in the simulator/optimizer 200, may manage time 1005 so that path dependency is accurate, interactions are properly calculated, and subsystem decisions and control occur in the simulation 1000 as policy or control would implement those decisions during actual operation.

At the beginning of the time period of interest shown in FIG. 10, many industrial systems have service contracts 1010 that stipulate how the physical apparatus will be utilized so that maintenance or performance guarantees will be honored. These contractual arrangements may benefit an operator by shifting risk to a service provider such as, for example, an OEM. However, the terms of the agreements can limit operations of the asset over a certain limit, rate, or cycle pattern or else trigger a risk share payment or nullify the performance-based service along the terms of the contract. The simulator/optimizer 200 may call the terms of these contracts 1010, in digital logic form, to establish the operating limits during the one or more time periods being explored (e.g., time 1005). The simulator/optimizer 200, after establishing the contractually feasible bounds of a current or base case, may then calculate during a simulated future time 1005 the value that was constrained by the contract terms, subject to the physical or regulatory limits of the asset or its operations so as to avoid calculating an infeasible operating point. Further, a simulated life consumption may be totaled for the evaluation period and added to the total at the start of simulation to not only calculate a life-limiting constraint but also available operating points not fully exploited. A next evaluated interval may then be presented with the then-currently-accumulated operating history, respecting the constraints that would have occurred during actual operations.

In this method, repairs may be scheduled in accordance with the contractual terms and simulated life exposures, ensuring that work scoping rules and policies are complied with. Repair or replacement actions may thus be brought into the optimization capability of the simulator/optimizer 200 for one or multiple periods, and the life consumption rates, as a function of physics-based engineering models and control models also being called, are varied to trade off operations cycles and set points versus work scope, efficiency, and dynamical response of the system, such as, for example, accelerated ramp rates. Further, multiple subsystems may have such contractual agreements, each of which may be managed by the simulator/optimizer 200.

Thereafter, subsystems models 1015 of the simulator/optimizer 200 may be called in the simulator/optimizer 200. In some examples, the subsystem models 1015, such as models 5 and 230 of FIG. 2, may be physics-based (e.g., a thermal heat balance)or data-driven (e.g., a neural net representation of the subsystem, or a set of rules describing the operation and performance characteristics of a subsystem). Further, multiple modeling methods may be employed for the same subsystem, combinations of subsystems, or the system at large. In replications of the simulation, these diverse modeling modalities in the presence of exogenous conditions (which may be deterministic and/or stochastic in nature) may enable a probabilistic range of outputs to be calculated according to the transfer function captured within the respective models 1015. The models 1015 may receive inputs from the system-of-systems simulation 1000, such as scenario configuration, exogenous factors, and history or state information, and calculate output performance based on those inputs. The interval of time 1005 is controlled b the simulator. In one example, the models 1015 are provided these inputs, and the models 1015 calculate outputs in discrete time steps from the beginning to the end of the interval of interest. The inputs to the models 1015 may vary throughout the interval as a function of changing exogenous conditions, and by direction of the simulator to account for such changes as anew operating setpoint, design, control dynamic, lineup, or maintenance result. In some examples, the system-of-systems simulation 1000 may employ a full enumeration, meta-heuristic search or a combination of both as optimization methods for enabling modification of the available plant design and operating decision support policy set points.

Computation may be effected in a single central processing unit (CPU) or multiple CPUs, such as in an elastic parallel cloud environment. One or more physical design models and operations decision support engines may govern the business-physical system operations and their initial data, and may be passed to the one or many CPUs for calculation (e.g., step 1020) as orchestrated by the factor simulation engine 240. Computing 1025 is performed by one or more CPUs operating in single thread mode per scenario, and through a time duration of interest. The simulated system may look to exogenous factors at the correct simulated time point, orchestrate data exchange to the requisite models, and accurately track state changes that are calculated by the business process and physical system models and decision support engines which the system calls in order to attain internally complete and coherent scenarios. In embodiments involving high performance computing with significant in-memory capability, each scenario is sequenced through computation with simulation-discrete time pauses and calls of subsystem models residing in high speed memory. In embodiments involving massively parallel environments, parallel scenarios may be formulated and configured to run and post-process aggregated.

A numerical simulation is implemented in the discrete event paradigm where the state of the business-physical system is determined in time windows (e.g., at step 1020), subject to the system and subsystem models of the business processes and decisions, and the physics of asset models subjected to endogenous and exogenous conditions, input assumptions and system decision support may be called as simulated time progresses. The beginning state and configuration of the business-physical system may be attained from plant and/or off-line data system(s) 1032, and used to populate the physics-based and/or data driven thermal or operational performance model(s) 1030. An a priori determined set of activities may be established, such as outage intervals specified in a service agreement 1035 or other governing contractual or regulatory requirement that may be attained from a contract configuration database 1037.

In example embodiments, the availability of a plant may be determined by the operational decision support 1040 orchestrated by the simulation 1000. One of the key metrics of a power plant is the availability of a plant that has direct correlation with that of its overall reliability. There could be scenarios where the condition or health of the asset is not at its best, and the plant operator might make a non-optimal decision of continuing operating the plant resulting in forced outages. These forced outages that result because of operator decisions are classified by the North American Electric Reliability Corporation (NERC) as forced outages due to economic repairs. Statistics from NERC database indicates that one of the leading causes of forced outages especially for combined cycle power plants are due to economic repairs. Due to the forced outages resulting out of economic repairs, the availability of the plant gets seriously affected. The availability of a power plant is a critical indicator for assessing the overall performance of the plant and its service to its customers.

A plant's availability creates value to its company, only if it can generate power at a profit by being available at the time it is required. In several real life situations, non-optimal decisions by plant operators can lead to forced outages and deratings that negatively influence the profitability of the plant. The operational decision support 1040 can play a key role in creating performance metrics that can establish a direct correlation between the plant's goals and its company's financial objectives. In example embodiments, the operational decision support 1040 orchestrated by the simulation 1000 may enable the plant operator to make optimal decisions such that the plant is made available to generate when required by the market and when the revenue and profit potential is highest. For example, power plants that are operated as peaking units are operated only when there is a surge in demand and there is a requirement to generate additional MWs of power. Since these peaking units are generally operated in an ad hoc fashion at specific time intervals in a year, they need not be maintained and manned for periods when their service is not required by the market. The operational decision support 1040 can enable deciding when to operate a plant and when not to, so that overhauls of critical power plant equipment can be undertaken without affecting the profitability and the availability of the unit. In some embodiments, the operational decision support 1040 can influence new plant design. This may be accomplished by using the decision support 1040 to reduce the dependency on expensive equipment redundancy and instead install advanced equipment monitoring equipment. In some embodiments, the operational decision support 1040 can be used to scope Contractual Service Agreements (CSAs) based on a plant's availability that could be beneficial to the generating company, wherein the scheduled maintenance can be restructured on an ongoing basis within financial constraints.

Other activities may be derived from within the operational decision support 1040 orchestrated by the simulation 1000, such as for example an asset duty assignment optimization, a bid quantity and price, a dispatch line-up, a maintenance event, a change of operating load or other such decisions as may occur in actual operations. These called decision support models may be fed temporally consistent data for their initial states and sequence. Further, the called decision models may be sequenced for a particular duration of time wherein they are given an initial data profile, and may be run through a certain duration of simulated time. With the knowledge of the decision support that occurred within that certain time duration and the resulting state of the simulated business-physical system, there is the option to configure decision support during or at the end of the simulated period that may be configured to pause the simulation 1000 and revert back to an earlier time 1005 in the simulation 1000 with a different set of preferences for decision support.

The assets 1045 within the system being simulated may have engineering models for aspects of their design intended to calculate thermal performance, or mechanical, electrical, or operational outputs that may be given a set of inputs. These models may be physics-based or may be data-driven representations of physical systems, trained to replicate the real world response of the assets. With assets 1045, and obligations set from business constraints (e.g., outage schedules set forth in service agreement 1035), the virtual plant and its corresponding business system may be simulated over a defined simulation interval (such as in fifteen-minute discrete time steps through a time duration that includes, for example, emulation of the last five years of operations through the forecasted next ten years forward, or emulation from the last maintenance interval to the present and simulated forward to a next maintenance interval). For example, the simulated virtual plant and the business system that owns and controls it may then be exposed to, in discrete time intervals, the specified exogenous factors from the established scenarios. The simulation 1000 may call other decision support subsystems in run time such as those subsystems that may be used to inform operations and control of the actual real-world ecosystem in clock time such as, for example, asset bidding into a connected market to estimate revenue, asset line-up and operations 1050, control 1055 and financial or operational performance tracking systems.

The system-of-systems simulation 1000 may be made aware of the dynamical response constraints in the known and designed physical system or may invoke a subsystem model that constrains the operating profiles and rates of the simulated system. Consistent with some embodiments, the constraints of the subsystem model may ensure that the set of assets and business processes in the simulation 1000 are made feasible as they interface with other systems that are not being simulated. As an example, such other systems may include an inner loop control of a complex system or the coupling of the simulated system to another process, such as a cogeneration plant to a petrochemical refinery, wherein the petrochemical refinery provides a set of inputs and outputs or constraints that are outside the modeling of the current system.

Complex systems (e.g., power plants), when in real-time operation, have the benefit of forward visibility to interim agreements related to their operation. Examples include assignment time and duty (e.g., as specified by an agreement of a particular duration), flexible pricing based upon periodic wear and tear, or consumption (e.g., as specified by a service contract). Given the knowledge of the interim agreements, the decision support policy and control set points may he informed by these periodic objectives, constraints, or rules. The system-of-systems simulation 1000 updates for such circumstances by managing the virtual clock ahead, and reverting with updates or boundary conditions for the replay of virtual time. Examples of factors needing treatment 1060 used in power generation include factored fired hours, starts, rate of change(s) in load(s), regulatory limits, capital expense or operating expense limits.

As the exogenous conditions are called during simulated time, and as the physics-based and operational models calculate state changes, a simulation run-time database 1075 captures each data point for use in replaying the simulation 1000 and to produce reports or queries (at operation 1065) either by users or by fault detection logic in the simulation 1000 infrastructure that mines for infeasibilities or targeted information of interest. The financial and operational post-processing 1080 also retrieves simulation data captured during run time for use in populating pro-forma financial statements, or outputs user interface scenario results 1085 that may be rapidly recalled without having to run the simulation 1000 again. The said database may be called from current or future simulations so as to save calculation time by recalling an exact prior point.

As discussed above, industrial systems, such as power plants, may act as both physical systems and business systems whose purpose is to create an economic return while also providing some physical benefit, such as power generation capability. The risks and returns of owning the power plant are contingent upon other assets in the owner's or operator's portfolio and the capital preferences of the enterprise. In at least some embodiments of the simulator/optimizer 200 described herein, an explicit mapping of those risk and return preferences, including financial and economic considerations, to specific plant design and operations decisions is provided so that alternative design and operations policy may be explored for opportunities to shift the economic performance of the industrial system from one risk/return state to a more desirable one.

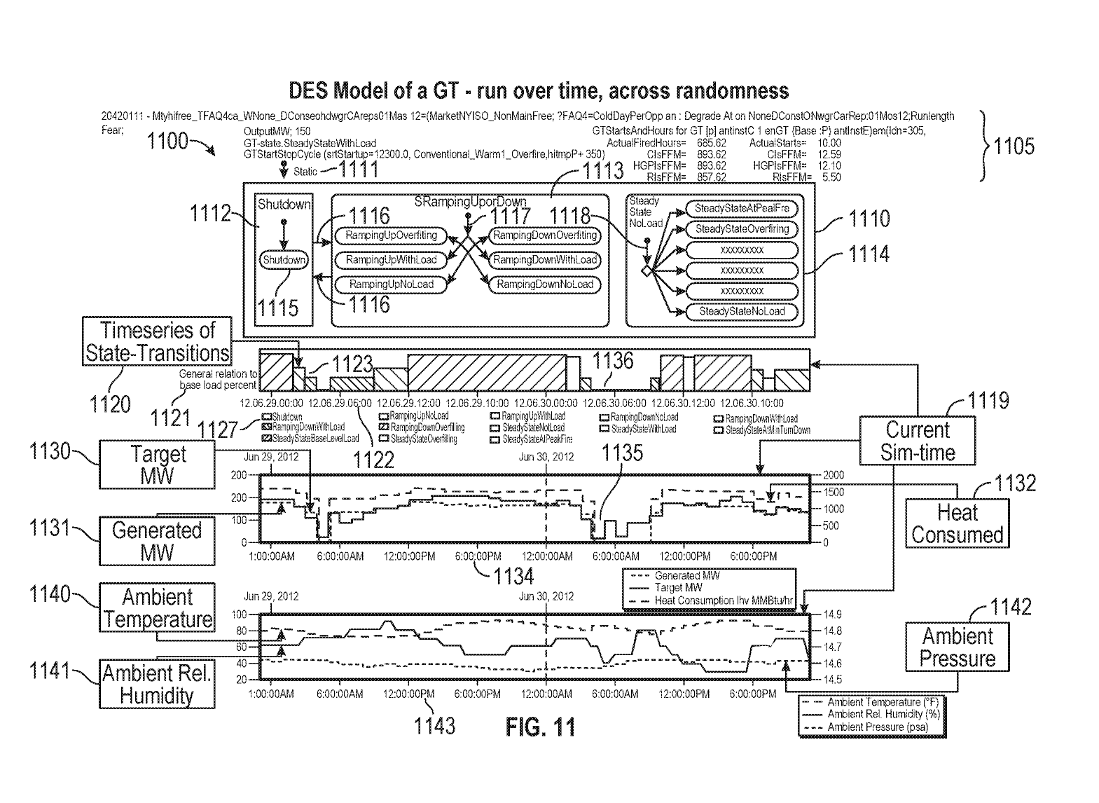

FIG. 11 is a graphical representation of an example discrete event simulation of a business-physical system 1110 run over time and across randomness. As illustrated in FIG. 11, the business-physical system 1110 is virtualized in a simulation that is indexed through time via the simulator (e.g., the simulator/optimizer 200), exposed to exogenous factors, and exercises the business logic and physical engineering models that describe how the real-world system might respond. The simulation may be employed, for example, to find design, operational, or contractual impediments to value creation, and to contemplate “what-if” scenarios for the purposes of policy change, modification, risk management, capital management, and revenue management.

The example discrete event simulation illustrated in FIG. 11 may result in the creation of asset states so that the virtual and physical world representations are consistent in terms of parameters and conditions. The operating paths of the simulated assets may be coherently tracked and decision support is made in the simulation based upon those accurately rendered paths and states. FIG. 11 illustrates the use of asset states by the discrete event simulation, which ultimately results in outputs 1100. FIG. 11 also illustrates the provisioning of summary statistics 1105 because these are industry norms. However, the discrete event simulation may track every state at every time step through the simulation period as well as the inputs and outputs of every decision point of the business-physical system 1110.

The business-physical system 1110 is illustrated in FIG. 11 to include three high-level modes. A first mode 1112 is a shutdown state 1115. At the beginning of the simulation period 1111 the unit is initiated as being shut down. The period of analysis may begin at the start of the simulated time. The duration of a state such as the shutdown state 1115 may be zero for the entire simulation period. Logic from operations engines (e.g., discussed above in reference to FIG. 10) determines the state and duration desired. The simulated system may or may not be able to be in a desired state at a given time period.

A second mode 1113 captures dynamics of the business-physical system 1110 during transitory periods. A third mode 1114 captures non-shutdown steady state operations at a given operations point. Transitions 1116 between states occur as an output of the system simulation as states change according to the business and physical dynamics of the virtualized system. Within the higher states or modes 1112, 1113 and 1114, are shut down states 1115, 1117 and 1118 with precise physical or business process meaning. The path of these states and transitions may be tracked for run-time decision support and post processing.

In FIG. 11, the states and their durations are displayed (at element 1120) as the business-physical system 1110 traverses the simulation period. FIG. 11 also includes an example depiction of the system state and a characteristic with an associated output vector value with respect to a given operating point such as full load 1123, which is displayed through time 1122. In the example simulation depicted by FIG. 11, the unit is operated above its full load rating for a significant portion of time.

The output 1131 of the system with respect to the desired load 1130 is depicted on a comparative basis through time 1134 with respect to energy consumed 1132 to achieve said output 1131. The energy consumed 1132 for an output may be a heat rate or other measure of efficiency and may be displayed instead of or in addition to the fuel input. As shown in FIG. 11, at time 1135 (e.g., 0500 AM) on time 1134 the system was targeted to produce between 20 to 100 megawatts. However, the system was in shutdown state 1136, and was thus likely losing revenue.

The business-physical system 1110 may have factors within its control such as the designs and operations policies of its subsystems. These endogenous factors are captured in engineering and operations decision support that is orchestrated by the system-of-systems simulator. Consistent with some embodiments, the system 1110 responds to factors that may be outside of its control, but that have a value that impacts the performance or operations of the system 1110. Examples of such factors include ambient temperature 1140 (e.g., air density), relative humidity 1141 (e.g., air density and water content), and ambient pressure 1142 (e.g., air density) depicted over the simulation period 1143. These factors may be provided as inputs to the engineering models, influencing the operating entitlement of the system 1110 along with choices made.

During simulation run time, the time 1119 and the one or more aspects of endogenous or exogenous factors remain consistent with respect to feasible correlation and path. Any point in time may be recalled later for analysis, understanding of dynamic response, or comparison of expected to actual results as the real-world operations unfold.

In example embodiments, the systems and methodologies disclosed herein may be utilized to calculate the interrelationship with respect to an industrial system's financial risk and return, between the physical plant and its business and physical operations with service contract terms to produce a highest lifecycle net present value for the provider of the contractual service contract. The customer may use such contracts and to jointly maximize total NPV, subject to the risk and return preferences of the two or more parties via a change in system revenue bidding or contract terms, asset design modification, asset operating lineup, asset maintenance actions and schedules.

In example embodiments, the systems and methodologies disclosed herein may be utilized to calculate the financial value and contribution to risk for a plurality of system constraints amongst asset design, industrial system duty and assignment in its production activities and revenues, system operations, maintenance timing and work scope, contractual terms and financial capital structures.

In example embodiments, the systems and methodologies disclosed herein may be utilized to simulate combinations of design, duty assignment and revenues, operating, maintaining, servicing and financing an industrial system comprised of one or more assets connected to the system evaluator and control, to produce a series of risk and return points corresponding to observed and simulated scenarios, said scenarios calculating the risk with replications of probabilistic assumptions, and then testing the combinations of different assumptions with one or more different scenarios which, if implemented, are financially feasible according to capital and operational expense constraints to create another series of risk and return relationships.

In example embodiments, the systems and methodologies disclosed herein may be utilized to implement a control orchestration using a discrete event simulation of an industrial system with asset and operational decision support models being called by the orchestration simulation, provided feasible and probabilistic inputs. The inputs, which may be received by asset models, are agent based state machines with embedded submodels with preference seeking objectives, physics-based and data-driven models—whose outputs provide mechanical, electrical and operational results back to the orchestration discrete event simulation. The orchestration may include calculating the key process indicators of the industrial system's design and operation and the variances of these key indicators.

In example embodiments, the systems and methodologies disclosed herein may be utilized to implement an industrial system control with discrete event simulation orchestrating the subsystem models which are state machines controlling physics and data-driven submodels, and able to match the simulated state of the subsystems to the actual physical and business process states at one or more points in a time continuum.

In example embodiments, the systems and methodologies disclosed herein may be utilized to implement industrial system control with discrete event simulation to orchestrate the business and physical system model-based ecosystem forward from a real or hypothetical state of the actual system at one or more points in a time continuum, enabling the forwarding and reversal of time through these known actual states, calculating the opportunity costs of improved components, operating points, business operational decision policy or services terms and maintenance work scope as well as the lost value from disproportionately consuming the physical system's life and the resultant loss of reliability flexibility and efficiency.

In example embodiments, the systems and methodologies disclosed herein may be utilized to implement industrial system modification and control with discrete event simulation to orchestrate the business and physical system sub-model based ecosystem, simulating the industrial system forward in time from a real or hypothetical state of the actual system at one or more points in a time continuum, enabling the forwarding and reversal of time through these model-derived or known actual states with the discrete event simulator, calculating the opportunity costs of improved components, operating points, business operational decision policy or services terms and maintenance work scope as well as the lost value from disproportionately consuming the physical system's life and the resultant loss of reliability, flexibility and efficiency, and calculating the expected value of the change in cash flows from the modeled system and its range of variances with respect to its Key Performance Indicators, implementing a design or operational change based upon the change in expected value and variances between one or more of the simulated scenarios.

In example embodiments, the systems and methodologies disclosed herein may be utilized to calculate scenarios and replications, and post-processing these generated data to calculate the risk and return Pareto frontier of the actual and hypothetical designs, configurations and/or operating policies for the business and physical system over a selectable time horizon, said time horizon beginning with a state instantiation which may be the actual physical state and operating regime of the real-world system, or multiple states as may change through time, or hypothetical states being tested for or derived by optimization as meeting life cycle objectives.

In example embodiments, the systems and methodologies disclosed herein may be utilized to provide forecasted results of the Key Performance Indicators of a system and their resultant financial risk and return given the system design, operations and their constraints, which updates the states of the connected models with feedback data from the business-physical system on an ongoing basis while the real-world system is in operation, and to provide optimal operations and modification decision support back to the systems operators, service providers, and designated stakeholders who interact with the actual industrial system so as to keep the performance criteria optimally controlled.

In example embodiments, the systems and methodologies disclosed herein may be utilized to calculate the present value of the connected system given forecasted or defined shock scenarios or one or more ‘what-if’ cases for the purposes of calculating the present value of cashflows and their variance over the forecasted economic period for the purposes of regulatory risk limitation, rationalization and calculating portfolio effects of one or more industrial systems whose capital structure in total is subject to capital constraints and probabilities of loss.

In example embodiments, the systems and methodologies disclosed herein may be utilized to consume exogenous time series assumptions related to one or more of market pricing, market competitive response of other suppliers or alternative providers of the subject industrial system's outputs, geophysical details, ambient conditions including but not limited to temperature, pressure, humidity, prices and availability levels of raw materials, fuels and other inputs as well as demand levels and unit sales revenues.

In example embodiments, the systems and methodologies disclosed herein may be utilized to directly/dynamically and iteratively call into first-principles based complex physical system emulators, such as modules that would use complex systems of differential equations and other elaborate algorithms to emulate the operation of gas turbines, steam turbines, heat-recovery steam generators, condensers, etc. while going through steady-states and transient-states of operation, as well as modeling the gradual degradation in performance based on path-dependent real and hypothetical histories (in real-world as well as in virtual/hypothetical worlds) of usage. Further, aspects of the present disclosure may provide the ability to benefit from such physics-based engineering emulators' realism and accuracy while wrapping the stochastic simulations over virtual time, operational optimizers working in-line with such simulations, as well as longer-term strategic optimizers and other decision support systems.

In example embodiments, the systems and methodologies may involve using path-dependent actual (from real life) and virtual (multiple statistical replications over simulated time axis) scenarios of usage, convert those to a sequence of projected (future) maintenance, repair and upgrade events, and in turn assemble a total cost of operations and ownership in relation to the projection of revenues generated. The foregoing information may be used to compute much more accurate levels of “variable cost”.

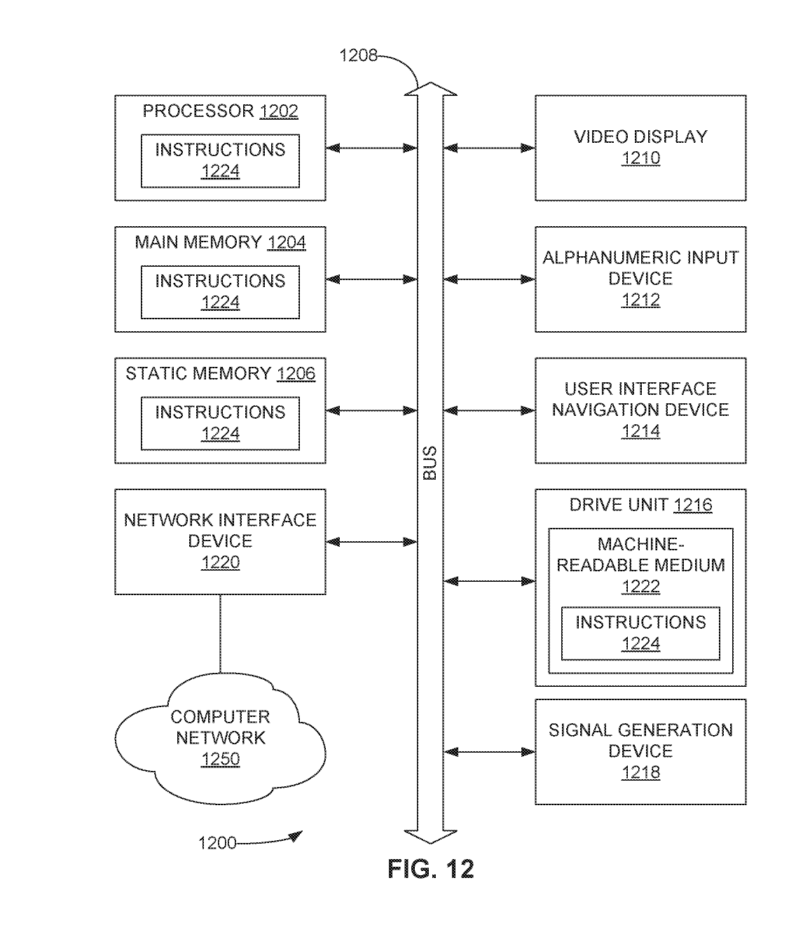

FIG. 12 depicts a block diagram of a machine in the example form of a processing system 1200 within which may be executed a set of instructions 1224 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions 1224 (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1200 includes a processor 1202 (e.g., a central processing unit (CPU), a graphics processing unit (GPU), or both), a main memory 1204 (e.g., random access memory), and static memory 1206 (e.g., static random-access memory), which communicate with each other via bus 1208. The processing system 1200 may further include video display unit 1210 (e.g., a plasma display, a liquid crystal display (LCD), or a cathode ray tube (CRT)). The processing system 1200 also includes an alphanumeric input device 1212 (e.g., a keyboard), a user interface (UI) navigation device 1214 (e.g., a mouse), a disk drive unit 1216, a signal generation device 1218 (e.g., a speaker), and a network interface device 1220.

The disk drive unit 1216 (a type of non-volatile memory storage) includes a machine-readable medium 1222 on which is stored one or more sets of data structures and instructions 1224 (e.g., software) embodying or utilized by any one or more of the methodologies or functions described herein. The data structures and instructions 1224 may also reside, completely or at least partially, within the main memory 1204, the static memory 1206, and/or the processor 1202 during execution thereof by processing system 1200, with the main memory 1204, the static memory 1206, and the processor 1202 also constituting machine-readable, tangible media.

The data structures and instructions 1224 may further be transmitted or received over a computer network 1250 via network interface device 1220 utilizing any one of a number of well-known transfer protocols (e.g. HyperText Transfer Protocol (HTTP)).

Certain embodiments are described herein as including logic or a number of components, modules, or mechanisms. Modules may constitute either software modules (.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 1200) or one or more hardware modules of a computer system (e.g., a processor 1202 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 1202 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 1202 that is configured using software, the general-purpose processor 1202 may be configured as respective different hardware modules at different times. Software may accordingly configure the processor 1202, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 1202 that are temporarily configured (e.g., by software) or permanently configured to perform the relevant operations. Whether temporarily or permanently configured, such processors 1202 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 1202 or processor-implemented modules. The performance of certain of the operations may be distributed among the one or more processors 1202, not only residing within a single machine but deployed across a number of machines. In some example embodiments, the processors 1202 may be located in a single location (e.g., within a home environment, within an office environment, or as a server farm), while in other embodiments, the processors 1202 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

This written description uses examples to disclose various embodiments, including the best mode thereof and also to enable any person skilled in the art to practice the embodiments, including making and using any devices or systems and performing any incorporated methods. The patentable scope of the embodiments is defined by the claims, and may include other examples that occur to those skilled in the art. Such other examples are intended to be within the scope of the claims if those examples include structural elements that do not differ from the literal language of the claims, or if the examples include equivalent structural elements with insubstantial differences from the literal language of the claims.

What is claimed is:

1. A method of optimizing operations of an industrial system, the method comprising:
accessing a plurality of criteria to be applied to the industrial system;
generating plurality of simulation scenarios based on the plurality of criteria;
simulating, using at least one processor, each of the plurality of simulation scenarios corresponding to a period of time to generate simulated physical aspects and simulated business aspects of the industrial system for each of the plurality of simulation scenarios; and
identifying at least one of the plurality of simulation scenarios for deployment in the industrial system based on outcomes of the simulating of each of the plurality of simulation scenarios.

2. The method of claim 1, further comprising generating the plurality of criteria to be applied to the industrial system, the generating of the plurality of criteria including:
generating a plurality of possible values for factors that affect operation of the industrial system; and
generating a plurality of possible states of the industrial system.

3. The method of claim 2, wherein the generating of the plurality of possible values for factors that affect operation of the industrial system includes calculating, for each simulation scenario of the plurality of simulation scenarios, a net present value of cash flows of the industrial system over the period of time.

4. The method of claim 1, wherein the plurality of criteria include at least one of a group comprising physical design criteria, maintenance work scope, service contract terms, capital financing, operational choice, and control criteria.

5. The method of claim 1, wherein the simulated business aspects include an economic return on investment in the industrial system for each simulation scenario of the plurality of simulation scenarios.

6. The method of claim 1, wherein the deployment of the at least one of the plurality of simulation scenarios in the industrial system causes a change to at least one aspect of the industrial system design, operations of the industrial system, maintenance of the industrial system, contractual obligations associated with the industrial system, dynamic control of the industrial system, or a financial structure of the industrial system.

7. The method of claim 1, wherein the identifying of the at least one of the plurality of simulation scenarios for use with the industrial system is based on a risk level associated with the at least one of the plurality of simulation scenarios being less than respective risk levels associated with a remainder of the plurality of simulation scenarios.

8. The method of claim 1, further comprising providing a suggestion of a modification to the industrial system that results in an increased return on investment as compared with a current configuration of the industrial system.

9. The method of claim 1, further comprising causing display of the simulated physical and business aspects on a user device.

10. The method of claim 1, further comprising varying at least one criteria of the plurality of criteria to produce a new simulation scenario, the at least one criteria being varied based on user input received from a user device.

11. A system for optimizing physical and business aspects of an industrial system, the system comprising:
a criteria module configured to gene ate a plurality of criteria to be applied to the industrial system, the criteria module further configured to generate a plurality of simulation scenarios based on the plurality of criteria; and
an optimization engine, comprising one or more processors, configured to simulate each of the plurality of simulation scenarios corresponding to a period of time to generate simulated physical aspects and simulated business aspects of the industrial system for each of the plurality of simulation scenarios, the optimization engine further configured to identify at least one of the plurality of simulation scenarios for deployment in the industrial system based on outcomes of the simulating of each of the plurality of simulation scenarios.

12. The system of claim 11, wherein the plurality of criteria include criteria pertaining to monetary aspects associated with operation of the industrial system, possible design modifications and upgrades to the industrial system, operations of the industrial system, control systems employed by the industrial system, service schedules, revenues generated by the industrial system, and financial costs associated with the industrial system.

13. The system of claim 11, wherein the criteria module is configured to generate at least a portion of the plurality of criteria based on input received from a user device.

14. The system of claim 11, wherein the criteria module includes a financial model to analyze cash flows of the industrial system based on initial investments, repair costs, costs of replacing components, cost of fuel consumed, and expected revenues, the expected revenues being based on market pricing for output of the industrial system.

15. The system of claim 14, wherein the financial model is further configured to provide indications of risk and return preferences of one or more stakeholders of the industrial system.

16. The system of claim 11, wherein the optimization engine is further configured to simulate each of the plurality of simulation scenarios by performing operations comprising calculating, for each simulation scenario of the plurality of simulation scenarios, an economic return and an economic risk associated with the industrial system.

17. The system of claim 11, wherein the optimization engine is further configured to:
compare a first economic return associated with a first simulation scenario of the plurality of simulation scenarios with a second economic return associated with a second simulation scenario of the plurality of simulation scenarios; and
determine a relative benefit of the first economic return to stakeholders of the industrial system based on the comparing of the first economic return to the second economic return.

18. The system of claim 15, wherein the optimization engine is configured to identify the at least one of the plurality of simulation scenarios for use with the industrial system based on risk and return preferences of the one or more stakeholders of the industrial system.

19. The system of claim 11, wherein the optimization engine is configured to identify the at least one of the plurality of simulation scenarios for use with the industrial system based on an economic return associated with the at least one of the plurality of simulation scenarios being greater than economic returns associated with a remainder of the plurality of simulation scenarios.

20. A non-transitory machine-readable storage medium embodying instructions that, when executed by at least one processor of a machine, cause the machine to perform operations comprising:
accessing a plurality of criteria to be applied to an industrial system;
generating a plurality of simulation scenarios based on the plurality of criteria;
simulating, using at least one processor, each of the plurality of simulation scenarios corresponding to a period of time to generate simulated physical aspects and simulated business aspects of the industrial system for each of the plurality of simulation scenarios; and
identifying at least one of the plurality of simulation scenarios for use with the industrial system based on the comparing of the simulated physical aspects and the simulated business aspects.
